(19) United States
(12) Patent Application Publication
(10) Pub. No.: US 2004/0044791 A1
(43) Pub. Date: Mar. 4, 2004

(54) Internationalized domain name system with iterative conversion

(76) Inventor: Daniel G. Pouzzner, Portsmouth, NH (US)

Correspondence Address: William F Heinze, Thomas Kayden Horstemeyer & Risley, Suite 1750, 100 Galleria Parkway NW, Atlanta, GA, 30339-5948, US

(21) Appl. No.: 10/296,105

(22) PCT Filed: May 22, 2001
(86) PCT No.: PCT/US01/16706

(51) Int. Cl. G06F 15/16; G06F 17/30

(52) U.S. Cl. 709/245; 707/4

(57) ABSTRACT

A system, method, and logic for managing data, including a database for implementing a key value operation, such as DNS resource record lookup, with a key having a predetermined encoding, such as Unicode. Also provided is an iterative converter, for iteratively converting the key from each of multiple encodings to the predetermined encoding before performing the key value operation with each converted key. The system may further include a validator for verifying that a syntax of each converted key is valid and a normalizer for normalizing each converted key.

### CROSS-REFERENCES TO RELATED APPLICATIONS

This application claims priority to copending U.S. patent application Ser. No. 09/575,753, filed on May 22, 2000, and entitled “Internationalized Domain Name System” and to copending U.S. Provisional Patent Application Serial No. Serial 60/279,799, filed Mar. 29, 2001, and entitled “Virtual Internationalized Domain Name System, both of which are hereby incorporated by reference into this document.

### BACKGROUND

1. Technical Field

The technology described here generally relates to data processing, such as electrical computers and digital processing systems with computer-to-computer data addressing, including an internationalized Domain Name System.

2. Description of Related Art

The modern Internet provides easy access to variety of information “resources” using a uniform naming syntax that works with various schemes for accessing different types of resources. Each of these resources is specified using a universal resource identifier (“URI”) consisting of an access scheme “identifier” ending in a colon, followed by a “path” for locating the resource on a specific computer. The access schemes are typically defined by standardized “protocols” while the path includes the “name” of the machine that is providing, or “hosting,” the resource.

a. Protocols and RFCs

The term “protocol” is generally used to refer to a procedure for regulating the transmission of data between computers. For data that is transmitted over the Internet, a “suite” of such protocols is continually evolving under the auspices of the Internet Society (“ISOC”) based in Reston, Va. (and on the Internet at www.isoc.org). The specification documents for these protocols are maintained by the Society's Internet Engineering Task Force (IETF) and published as “Requests for Comments,” or “RFCs.” These RFCs form a series of notes, starting from 1969, that discuss various aspects of computer communication including networking protocols, procedures, programs, and other concepts. The Task Force's “RFC Editor” maintains a master file of all RFCs (at www.rfceditor.org) that can be searched and downloaded over the Internet at no charge.

Every RFC is assigned an index number by which it can be retrieved. For example, RFC 2026, entitled “The Internet Standards Process—Revision 3,” documents the process used for the standardization of protocols. When a specification has been adopted as an Internet Standard, it is then given the additional label “STD,” but still keeps its former RFC number and its place in the RFC series. For example, STD 1, currently RFC 2800, is periodically updated to give the latest RFC number for all protocols and to indicate whether that RFC has been adopted as a standard.

Current RFCs may be made obsolete or supplemented by later RFCs as new protocols are developed. Another type of RFC standardizes the results of community deliberations about statements of principle or conclusions concerning the best way to perform some operation. This latter type is referred to as a “best current practice” and has been given the additional designation of “BCP.” Each of the BCPs, STDs, and other RFCs discussed here (including any updates) is hereby incorporated by reference into this document.

b. The Internet Protocol

STD 5 specifies the Internet Protocol, or “IP,” upon which all other protocols in the Internet suite are based. The fundamentals of IP are set forth in the RFC 791 portion of STD 5. In simple terms, each computer on the Internet (known as a “host” machine) has at least one “IP address” that uniquely identifies it from all other machines on the Internet. Data which is to be transmitted (for example, an e-mail message or Web page) is first divided into chunks, called “packets,” which each contain the sender's and receiver's Internet addresses.

Each of these packets is then consecutively sent to a “gateway” computer, often referred to as an IP router, or simply a “router,” that reads the destination address and then forwards the packet to an adjacent computer, which again forwards the packet to another computer. When the last computer recognizes the packet as belonging to a computer within its immediate neighborhood, or “domain,” it forwards the packet directly to the machine in the address. Once the packets arrive at their destination, the Transmission Control Protocol (STD 7), or “TCP,” defines how the packets are rearranged in the correct order. Together these two protocols are sometimes referred to as “TCP/IP.”

c. IP Addresses

Under STD 2 (entitled “Assigned Numbers”) and various other ancillary agreements, the Internet Assigned Numbers Authority (at www.iana.org) has been designated as the central coordinator for the assignment of unique IP addresses. These addresses are usually written in “dotted quad” notation as a series of four numbers separated by periods. Under the most widely used version of IP (Internet Protocol Version 4, or simply “IPv4,” discussed in RFCs 1812 and 2644), the numbers in each segment are limited to 8 bits and thus range from zero to 255. For example, 199.103.194.129, 207.106.7.7, 209.124.64.11, and 207.230.32.23 are IP addresses for various machines that are used by an organization called .NU Domain.

In practice, however, a machine will often have more than one IP address if it “hosts” more than one connection to the Internet. Alternatively, a pool of temporary IP addresses may be shared between a number of host machines so that a different address can be allocated each time one of the machines is connected to the Internet. Other address formats can also be used. For example, a newer version of IP, called “IPv6” (discussed in RFCs 2373 and 2463), is currently being implemented in order to allow numerical IP address segments as long as 128 bits.

d. Host Names

Early configurations of the Internet required users to manually type these numeric IP addresses every time that they wanted to transmit data to another machine on the network. Since names are generally easier for people to remember than numbers, that practice quickly evolved into the use of symbolic host names as surrogates for the numeric addresses. For example, instead of typing “199.103.194.129,” a user might type “NUDOMAIN.” That text would then be automatically associated with the numeric IP address in a process that is loosely referred to as “mapping” of a name to a location. As discussed below, this type of mapping is usually performed using a database “lookup.” However, the association of an numeric IP address with a textual host name may be carried out with a wide variety of other technologies.

On the modem Internet, these symbolic host names are conceptually organized into the “domain name space” hierarchy set forth in RFC 1591, entitled “Domain Name System Structure and Delegation.” Each area of the Internet is identified by a “domain name” which consists of that part of the domain name space that is at or below the portion of the hierarchy specified by the name. An area is then referred to as a “subdomain” of another domain if it is contained within that domain.

A domain consists of a set of locations that are logically related. At the top of this hierarchy are the now-familiar generic top level domains, or “gTLDs,”—.com, .edu, .gov, .ext, .mil, .net, .org, and .int. There are also top level “country” domains based upon two-character abbreviations for each country. A second level is then added to each top level domain name in order to identify a particular area or machine in that top level domain. For example, the “.nu” top-level domain is set aside for the pacific island of Niue and “whats.nu” identifies a host machine in the .nu domain. That particular machine is operated by the Network Information Center, or “NIC,” for the .nu domain which acts as the registrar for all second level names in the domain.

e. Uniform Resource Locators

The most common form of URI is the uniform resource locator, or “URL,” described in RFC 1738 and others. In broad terms, a network resource is located in the domain name space by a string of characters forming one or more “labels” (each up to a maximum of 63 characters) where each label is separated by a period and the last label is a TLD identifier. The currently preferred convention for these labels is set forth in RFCs 952 and 1123 which require that labels include only the numerals 0-9, the letters A-Z, and the hyphen character. These characters are therefore referred to as “DNS-legal characters.” In addition, no blank or space characters are permitted and no distinction is made between upper and lower case characters.

A domain name that includes only DNS-legal characters and satisfies any other syntax requirements of the DNS protocol is said to be a “DNS-legal name” or “fully-qualified name.” However, the definition of which characters and names are DNS-legal is flexible and expected to change as new domain naming conventions are adopted. Certain of the remaining DNS-illegal characters, such as the “unsafe” or “reserved” characters described in RFCs 1630 and 1738, are particularly troublesome when used in domain names and are sometimes referred to as “unclean” characters.

f. Internationalization of URLs

In countries where English is not the native language, DNS-legal domain names are typically created by transliterating a symbolic name from another language into a DNS-legal name using only the limited group of “Latin” characters for the letters and numbers that are discussed above. However, since many languages do not have an accepted standard for transliteration, there can be several plausible transliterations for any non-English, symbolic host name. Furthermore, even if a meaningful domain name can be created through transliteration, there is no guarantee that a casual user will be able to easily remember that name, or spell the transliteration using only the English alphabet. Consequently, the requirement for using only these Latin letters and numbers can be quite burdensome, especially for inexperienced users. These and other issues surrounding the “i18n” (referring to the 18 letters between the “i” and “n” in the term “internationalization”) of various Internet protocols are discussed in RFC 2825 entitled “A Tangled Web: Issues of i18n, Domain Names, and Other Internet Proposals.”

g. The Domain Name System Protocol

As discussed in RFC 2825, internationalization of the Domain Name System (“DNS”) protocol is central to the globalization of language representation facilities on the Internet. The modem DNS protocol arose out of the need to match, or “map,” host names in textual format with their corresponding numeric IP addresses. Originally, the names of every host machine on the Internet's predecessor network were mapped to their numeric addresses using a single database file, or table, that was maintained by the Stanford Research Institute NIC. This one electronic file was then periodically updated and copied by all other host machines on the network as is generally discussed in RFC 953, entitled “Hostname Server.”

While the Stanford NIC could assign numerical IP addresses in a way that guaranteed uniqueness, it had no authority over the registration of corresponding host names. Consequently, there was nothing to prevent someone from adding a host name that was the same as one already in the table for a different IP address. This procedure often resulted in “name collisions” when an attempt was made to associate one name with multiple addresses. Furthermore, as the number of host machines on the early network mushroomed beyond expectations, this so-called “hosts.txt” file became much too unwieldy for one organization to easily administer.

The managers of the early Internet therefore sought a new system that would allow for each host to administer its own local mapping data while still making that data globally available to any other host on the network. In addition, they sought to eliminate the bottleneck created by the capacity limitations of keeping all of the data on a single host machine. Paul Mockapetris was given the responsibility for designing a new architecture for accomplishing these goals and, in 1984, he released RFCs 882 and 883 which describe the fundamentals of the “Domain Name System,” or “DNS,” protocol. These RFCs were eventually superseded by RFCs 1034 and 1035, and further augmented by other RFCs, to form the modem DNS protocol that has been adopted as STD 13.

In simple terms, the current DNS protocol provides for a distributed database for mapping the names of host machines to their IP addresses. The DNS concept is therefore sometimes referred to as a “distributed name space” since the entire database no longer resides on just a single host computer in a “flat name space” as with the conventional domain name translators discussed above. The DNS protocol thus allows a program running on one host machine to perform the association of a symbolic host name with a numeric IP address (and/or other information) without the need for all machines to have a complete and accurate database of all names and addresses, or the need for a single machine to receive all requests for information.

The first software implementation of the DNS protocol, called JEEVES, was written by Paul Mockapetris. A later implementation, called Berkeley Internet Name Domain, or “BIND,” was written by Kevin Dunlop for the UNIX operating system. Since most name servers use the Unix operating system, and since BIND is open and available at no charge from the Internet Software Consortium in Redwood City, Calif. (and at www.isc.org), BIND quickly became the most popular implementation of the DNS protocol and is hereby incorporated be reference into the present application. However, other DNS implementations for Unix and other operating systems are also readily available from a variety of distributors. An overview of the BIND software implementation of DNS can be found in “DNS and BIND” by Paul Albitz and Cricket Liu and published by O'Reilly & Associates of Sebastapol, Calif. (at www.oreilly.com) which is also incorporated by reference here.

h. Name Servers and Resolvers

BIND and other implementations of the DNS protocol typically include two major components called a “name server” and a “resolver.” In simple terms, a server is a computer or program which provides some service to other “client” computers or programs. The connection between client and server is normally by means of message passing, often over a network, and uses some protocol to encode the client's requests and the server's responses. The server may run continuously as a “daemon,” waiting for requests to arrive, or it may be invoked by some higher level daemon which controls a number of specific servers (inetd on Unix).

The term “daemon” generally refers to a program that is not invoked explicitly, but lies dormant waiting for some condition(s) to occur. The idea is that the perpetrator of the condition need not be aware that a daemon is lurking, though often a program will commit an action only because it knows that it will implicitly invoke a daemon. Unix-based systems typically run many daemons, chiefly to handle requests for services from other hosts on a network. Most of these are now started as required by a single real daemon, “inetd,” rather than running continuously. This particular Berkeley daemon program, also known as “netd,” listens for connection requests or messages for certain ports and starts server programs to perform the services associated with those ports. Daemon and “demon” are often used interchangeably

There are many servers associated with the Internet, such as those for Network File System, Network Information Service (NIS), Domain Name System (DNS), FTP, news, finger, and Network Time Protocols. The most common example hardware server is a file server which has a local disk and services requests from remote clients to read and write files on that disk, often using Sun's Network File System (NFS) protocol or Novell Netware on IBM PCs.

The name server receives DNS protocol queries (i.e., requests for information about a host or other “resource” on the Internet) and returns DNS protocol replies that either contain the answer to the query or a referral to another name server that is more likely to have the desired information. The name server also stores complete information about some portion of the domain name space for which it is authoritative, called a “zone,” including the locations of any name servers for which it has delegated authority for a “subzone.”

For example, at the top-level of the domain name space there are thirteen “root name servers” that are authoritative for directing queries concerning the generic top-level domains and country domains to the various name servers for those domains. Similarly, the name servers that are operated by .NU Domain are authoritative for the “.nu” zone to the extent that authority for any subdomains has not been delegated by .NU Domain to other servers.

Resolvers, on the other hand, merely obtain resource records from name servers. Normally they do so at the behest of an application, like a browser, but they may also do so as part of their own operation. The resolver is typically located on the same machine as the program that requests the resolver's services. However, the resolver can often consult name servers that are running on other host machines.

Information about the resources in a particular zone is stored on the name server in the form of “resource records” in a “zone data file.” Each record in the zone data file data is typically represented by one “line,” or row, that contains several “fields,” or columns. Certain fields may also be designated as “key fields” which are then indexed to speed the lookup of unique identifiers, or “keys,” for each record. The set of keys for all records in the database forms an “index.” Multiple indexes may also be built for the zone database.

The first column in each resource record contains the “owner” domain name where that resource is found. Other columns contain information concerning the record type, class, and/or other information as set forth in STD 13 and others. For example, a type “A” record would contain a name-to-address mapping with four columns, such as “whats.nu IN A 209.124.64.1,” where “whats.nu” is the name of the owner of the Internet (“IN”) host at the indicated numeric IP address (“A”). The master file containing these textual records is then highly encoded before being stored on the name server in its encoded form. All of this data can then be transferred between name servers by simply copying the resource records to another name server.

When a user program, such as a web browser, issues a request for a resource record, the resolver formulates a “query” to the local name server. If that name server has fielded a request for the same information within a certain period of time (to prevent passing old information), it will locate, or “lookup,” the information in its own memory (if possible) and send a reply. The lookup is typically a key value retrieval operation; however, it may also be completed using a variety of other methods such as on-the-fly computation, hashing and/or conversion algorithms, and various other indexing techniques.

If the name server is unfamiliar with the requested information, it will then make a referral to another name server that is more likely to know the answer, typically one for a zone at a higher level in the hierarchy of domain name space. The resolver will then attempt to “solve” the problem by asking the second server for the same information. If that does not work, the resolver will ask yet another server until it finds one that knows the answer to its query, or exceeds a time limit for fulfilling the request and issues an error message.

i. Wildcard Resource Records

The actual algorithm that is used by the name server to find a particular resource record will depend upon the operating system and data structure being implemented. However, most name servers provide for the use of “wildcard” resource records that control the response when the server is unable to answer certain kinds of queries. These wildcard records can be thought of as instructions for synthesizing a new resource record under certain conditions. When those conditions are met, the name server creates a resource record with an owner name equal to the query name and with contents taken from the wildcard record.

Wildcard records are typically designated in the master zone file by owner names starting with an asterisk (*). This facility is most often used to create a zone that will be used to forward mail from the Internet to some other mail system. The general idea is that any name in that is not already in a certain portion of the zone files will be presumed to exist nonetheless. For example, adding a wildcard resource record such as “*.whats.nu IN MX mail.nic.nu” will cause mail for the whats.nu domain to be forwarded to the mail server at the network information center for the .nu ccTLD, unless other resource records for the whats.nu subdomain are available in the zone files.

j. WHOIS Service

Another component of BIND, and other implementations of DNS protocol, is the WHOIS service generally described in RFC 954 entitled “Nickname/NHOIS Protocol.” This service allows users to determine whether a particular domain name is available for registration, and, if not, where the current registrant can be reached. Many WHOIS servers are also available with forms-based interfaces that make them easier to use. For example, the domain name registry for the .nu TLD is searchable using such an interface (at http://www.whats.nu).

k. The HTTP and SMTP Protocols

In addition to the DNS protocol, most web-browsers also rely on the Hyper Text Transfer Protocol (“HTTP,” RFCs 1945 and 2068) for exchanging text files, graphic images, sound, video, and other multimedia files on the Internet. Under the HTTP, a file may contain a URL reference to other files whose selection will elicit a data transfer request.

After receiving and interpreting an HTTP request message from a web-browser, the HTTP server will typically respond with a “full-response message” in which the first line is referred to as the “status-line.” The status-line contains a three-digit “status-code” element and a short textual description of the code. For example, if the action that was requested in the query was successfully completed, then the response message includes a “2XX-series” status code. If the server has not found anything that matches the request, then the response will include a 4XX-series “client error” status code (such as a “404” status code) and a descriptive error message such as “file not found.”

The 3xx-series status codes in HTTP responses are reserved for “redirection” and indicate that further action needs to be taken by the client that made the request. For example, when the requested resource resides temporarily at a different address, the response message might include a “302” status code with the new address. The requesting client will then redirect itself to the new address. The redirection may be automatic or it may require the user to manually click on a hyperlink before receiving information from the temporary HTTP server.

HTTP also allows for the identifications of certain types of what it refers to as “character sets” by case-insensitive tokens. The complete set of tokens are defined by the IANA Character Set registry. However, because that registry does not define a single, consistent token for each character set, RFC 1945 defines “preferred names” for those character sets most likely to be used with HTTP entities. These character sets include those registered by RFC 1521—the US-ASCII and ISO-8859 character sets—and other names specifically recommended for use within MIME charset parameters.

The “charset” parameter in the HTTP Protocol is used with some media types to define the character set of the data. When no explicit charset parameter is provided by the sender, media subtypes of the “text” type are defined to have a default charset value of “ISO-8859-1” when received via HTTP. Data in character sets other than “ISO-8859-1” or its subsets must be labeled with an appropriate charset value in order to be consistently interpreted by the recipient.

RFC 1945 points out that many current HTTP servers provide data using charsets other than “ISO-8859-1” without proper labeling. This situation reduces interoperability and is not recommended. To compensate for this, some HTTP user agents provide a configuration option to allow the user to change the default interpretation of the media type character set when no charset parameter is given.

HTTP also provides for “product tokens” that are used to allow communicating applications to identify themselves with an optional slash and version designator. Most fields using product tokens also allow subproducts which form a significant part of the application to be listed, separated by whitespace. By convention, the products are listed in order of their significance for identifying the application.

The Simple Mail Transfer Protocol (“SMTP,” STD 10) is based on a model of communication that is somewhat similar to HTTP in that it provides for the transport of mail across networks in what is referred to as “SMTP mail relaying.” Using SMTP, mail can be transferred on the same network or to some other network via a relay or gateway that is accessible to both networks. This transmission normally occurs directly from the sending user's host to the receiving user's host, or via one or more relay SMTP servers. In the latter case, an intermediate host that acts as either an SMTP relay or as a gateway into some other transmission environment that is usually selected through the use of the Mail exchanger (“MX”) mechanism in DNS that is discussed above with regard to wildcard resource records. In this way, a mail message can pass through a number of intermediate relay or gateway hosts on its path from sender to ultimate recipient.

I. Character Encoding

Before mapping a host name to its numeric IP address, a name server must first decipher the binary code representing the resolver query. Part of this query will include a binary representation of a string of characters that make up the symbolic host name. In order to describe this character decoding process, this document follows the character encoding model set forth in the Unicode Technical Report #17” available from the Unicode Consortium in Mountain View, Calif. (and at www.unicode.org), which is hereby incorporated by reference into this document. However, other models are equally applicable, including RFC 2130 entitled “The Report of the IAB Character Set Workshop held 29 Feb. 29-Mar. 1, 1996,” Martin Düerst's and François Yergeau's “Character Model for the World Wide Web” published by the World Wide Web Consortium (at www.w3.org/TR/charmod), and “Requirements of Internationalized Domain Names,” by James Seng, published by The Internet Engineering Task Force (at http://www.ietf.org/internet-drafts/draft-ieff-idn-requirements-02.txt), all of which are also incorporated by reference here.

In broad terms, a “character” can be any member of a set of elements that is used for organization, control, or representation of data. A character is usually thought of, however, as the smallest component of a written language that has semantic value. Each character comes in many “forms” which can be distinguished by width, height, size, position, rotation, case, font, italicization, underlining, or other similar typographical nuance. The collection of these symbols for a particular language, or languages, is often referred to as a “script.” Characters are typically defined in a script by specifying the names of characters and a sample presentation of the characters in visible form referred to as a “glyph.”

When used to express host names, these characters usually take the form of a printable symbol having phonetic or pictographic meaning that may also form part of a word of text, depict a numeral, and/or express grammatical punctuation. For example, as discussed above (and described in RFC 1034), Internet host names are conventionally formed by a string of characters that are selected from the “DNS-legal” character set which is limited to a portion of the Latin script including the letters of the alphabet used in the U.S., the numerals in the decimal number system, and certain special symbols such as the hyphen (“-”).

The wide range of modern scripts that are used for conveying textual information has resulted in a unique set of challenges for the transmission of data between computers. For example, RFC 2130 notes that even the term “character set” does not have a well-defined meaning in this area. Therefore, in this document, a character set is simply a group of characters to be encoded while a “coded character set,” or “CCS,” is a character set for which each character has been assigned a numerical “code value.”

The CCS mapping is typically defined by a table providing one-to-one correspondence between values and characters arranged in “code positions,” inside the table. The code positions are then defined by a numerical index, called a “code point” or “scalar value,” that may also implicitly define the code value. Many coded character sets also have code positions that are designated for “control functions” other than displaying text. Some code positions may also be reserved for future characters and/or control functions. Various aspects of coded character sets are sometimes loosely referred to as “character encodings,” “coded character repertoires,” “character set definitions,” “code pages,” “character sets,” “charsets,” or “code sets.” ISO 10646, US-ASCII, and ISO-8859, discussed below, are generally accepted standards that define coded character sets. For example, in the ISO 10646 coded character set, the equivalent decimal code values for “a,” “!,” and “a” are 97, 33, and 228, respectively. Further information about various character names, or “mnemonics,” and character sets is available in RFC 1345.

The “character encoding form,” or “CEF,” defines the size of the “code unit” and the number of code units that are used to represent each character. The encoding form thus defines how the values from the CCS are converted into sequences of a base datatype. Since most character encoding forms use a single 7-bit (“septet”) or 8-bit (“octet”) code unit for each character, the CEF is often implicitly understood. However, the use of multiple code units and/or variable length code units for each character is becoming more common.

The “character encoding scheme,” or “CES,” is a mapping of code units into serialized byte sequences that are dictated by the computer architecture being used. Such “serialization schemes” define the byte-order for multiple code unit CEFs and any switching between different CCSs. For example, the UTF-8 encoding scheme (discussed below) applies only to the ISO 10646 coded character set while the ISO 2022 encoding scheme can be applied to a variety of coded character sets. Thus, the character encoding form maps code points to code units, while the character encoding scheme maps code units to bytes.

The complete mapping of a character string to a sequence of bytes is referred to here as a “character map” or “CM.” A simple character map thus implicitly includes a CCS mapping from characters to code values, a CEF mapping defining the width and number of code units for each character, and a CES mapping from code units into a series of bytes. The use of such character maps is also referred to here as character mapping, character map encoding, “character encoding,” or simply “encoding.”

Where the CEF is implicitly defined to be 8-bits long (as in “Requirements of Internationalized Domain Names” by James Seng discussed above) a combination of one or more CCSs with a CES results in a “charset” character map for converting a sequence of octets into a sequence of characters. The names of various such charsets are registered with the Internet Assigned Numbers Authority (“IANA”) using the procedures set forth in RFC 2278. The IANA Character Set Register is available on the Internet (at http://www.isi.edu/in-notes/iana/assignments/character-setsauthority).

Various character maps have been developed in order to express textual characters in the binary language used for data transmission. “A Brief History of Character Codes in North America, Europe, and East Asia” by David J. Searle and published in 1999 at the Sakamura Laboratory, University Museum at the University of Tokyo (and published at www.tronweb.super-nova.co.jp/characcodehist.html) is noteworthy in this regard and incorporated by reference here. According to Mr. Searle, the first widely-used binary character code for processing textual data was demonstrated by Samuel Morse in 1838.

“Morse Code” is based on combinations of two possible values, either a dot or a dash, for each character in the set defined by the letters in the English alphabet and certain punctuation marks. However, unlike the character encoding form used by many modem binary computers where the length of a code unit is typically fixed at seven or eight bits, the number of dots and/or dashes representing each character in Morse Code can vary from one to six. When actually transmitted, the character encoding scheme calls for each dash to be encoded as a signal which is three times as long as the signal for a dot. The individual characters are then separated by a time interval equivalent to one dot, while the space between the individual characters of a word is separated by an interval equivalent to three dots, and the words in message are separated by an interval equivalent to six dots.

The next great leap in telegraphic technology involved the printing telegraph, or “teleprinter,” patented by Jean Baudot in France in 1874. Messages using Baudot's code were printed on narrow paper tapes by operators using a special five-key keypad. Unlike the variable-length encoding form of the Morse Code, every character in the Baudot Code was represented by a unique group of five binary digits. Since there were insufficient combinations of fixed-length, 5-bit code units all of the letters of the Latin alphabet, Arabic numerals, and punctuation marks, Baudot also added a “locking-shift” encoding scheme (similar to the shift key on a manual typewriter) to essentially double the number of characters that could be transmitted. These latter “control characters” were encoded as marks pr spaces on the tape representing a “current on” or “current off” condition in the transmitter. After modifying Baudot's code to include just 55 elements—thus allowing three places for national variants of the character set—it was adopted as a standard for teleprinters in 1932 by the Comité Consultatif International Télégraphique et Téléphonique (now the International Telecommunications Union, or “ITU”) and designated as “International Telegraphic Alphabet No. 2.”

The rapid development of communications and data processing technologies in the United States during the first half of the 20th century led to the need for a standard character map that could handle the larger character repertoire of an English-language typewriter. The American Standards Association (or “ASA,” which later changed its name to the American National Standards Institute, or “ANSI”) studied this problem and developed a 7-bit coded character set to replace the 5-bit Baudot set. In 1963, the ASA designated its character map as the American Standard Code for Information Interchange, or “ASCII.” However, this original version of the ASCII code left out too many characters and it was not until 1968 that the currently used 7-bit ASCII character set was defined with 96 printing characters and 32 control characters for designating various communication functions other than displaying text.

ASCII Code was ultimately adopted by all U.S. computer manufacturers. Since U.S. vendors dominated the world market for computers at the time, ASCII Code also became the de facto international standard. It therefore became necessary to further modify the ASCII character set for use with other languages. Since there are now many national variants of ASCII, the original version of the ASCII coded character set is often referred to as “US-ASCII,” or by the name of its formal specification, ANSI X3.4-1986, which is incorporated herein by reference.

In order to address the problem of character map variations between nations, in 1967 the International Organization for Standardization (“ISO” in Geneva, Switzerland) issued Recommendation 646 which is also incorporated herein by reference. “ISO 646” basically called for the ASCII character set and character encoding scheme to be used except for ten character positions which were left open for “national variant” characters. The default characters for those ten positions were then specified in a version of the recommendation known as the International Reference Version, or “IRV.” US-ASCII was also used as the basis for creating various other 7-bit character maps for languages that did not employ the Latin alphabet, such as Arabic, Greek, and Japanese. At least 180 character codes based on similar extensions of ASCII have now been registered with the ISO.

While 7-bit character codes such as ASCII and ISO 646 are generally sufficient for processing English-language data, they are usually inadequate for processing data expressed in the larger, non-Latin scripts that require much larger character sets. It therefore became necessary to create a number of new codes with larger code unit lengths that would allow for expanded character sets. To that end, ISO 2022 was created to define a general structure for 7- and 8-bit coded character sets, and is hereby incorporated by reference into the present application. Among other things, ISO 2022 establishes how code value tables are laid out, how rows and columns in a table are numbered, and the position of “fixed assignments” within the tables for various control character code values.

Once ISO 2022 was in place, numerous other 7- and 8-bit character maps were formulated in a manner similar to ISO 646. One of the most widely used of these character sets is specified in ISO 8859 and is also incorporated by reference here. ISO 8859 is a multi-part specification using an 8-bit encoding form that was designed for the data processing needs of Western and Eastern Europe. Each part of the ISO 8859 “family” of character sets extends the ASCII character set in different ways, with different special characters for various languages and cultures. For example, ISO 8859-1 (so called “Latin-1”) contains the ASCII character set and a collection of additional characters needed for the languages of Western and Northern Europe, while ISO 8859-2 (“Latin-2”) is constructed for languages of Central and Eastern Europe. ISO 8859 is similar to ASCII in that code positions 0-127 contain the same characters as in ASCII, while positions 128-159 are reserved for control characters, and positions 160-255 are used differently in each part of the ISO 8859 family.

ISO 10646 is one of the latest attempts to establish a standard multilingual character map and is often referred to as a Universal Character Set (“UCS”). Currently tens of thousands of characters have been defined in what amounts to a very large extension the ISO Latin-1 character set. “Unicode” is a particular UCS standard specified by the Unicode Consortium in Mountain View, California (and at www.unicode.org) to define a character set that is compatible with ISO 10646. In principle, the Unicode Standard corresponds to the Basic Multilingual Plane, or “BMP,” of ISO 10646, or “ISO-10646-1.” However, the other “planes” of ISO 10646 have not yet been defined and, in practice, the terms ISO-10646 and ISO-10646-1 are used interchangeably. The third, and current, version of the Unicode standard claims to be identical to ISO 10646-1:2000 entitled “Information Technology—Universal Multiple Octet Coded Character Set (UCS)—Part 1: Architecture and Basic Multilingual Plane,” which is also known as the “Universal Character Set,” or “UCS.” Consequently, the terms ISO 10646, Unicode, and UCS are often used interchangeably. ISO-10646 and the Unicode Standard Version 3.0 (including Unicode Standard Annex #27 entitled “Unicode 3.1,” and other annexes, reports, or supporting documentation) are hereby incorporated by reference into this application.

m. Unicode

The Unicode Standard provides for text elements to be encoded as composite character sequences which, when presented, are rendered together. For example, “a” may be encoded as a “composite character” by rendering “a” and “A” together. Such “composed character sequences” are typically made up of a base letter, which occupies a single space, with one or more formatting “marks.” A combining character whose positioning in presentation depends on the upon its base character is referred to as a “nonspacing mark” while all other combining characters are referred to as “spacing marks.”

Certain characters may also be encoded as “precomposed characters” represented by a single code value rather than two or more code values which are combined during rendering. For example, the character “ü” can be encoded either as the single code value U+00FC “ü” or as the base character U+0075“ü” followed by the non-spacing character U+0308“\ddot{}”. The Unicode Standard offers such precomposed characters as an alternative composed character sequences so as to retain compatibility with, and correspondence to, established standards, such as Latin 1, that include many precomposed characters such as “ü” and “\ddot{n}.” The precomposed characters that are defined by Unicode are therefore sometimes referred to as “compatibility characters.”

Under the Unicode Standard, all precomposed characters can be consistently “decomposed” for further analysis. For example, a word processor that imports a text file containing the precomposed character “ü” may decompose that character into a “base” character “u” followed by the non-spacing “combining” “character” “\ddot{}”. Once a character has been decomposed, it is usually easier for a word processor, or other application, to work with the character because it can now easily recognize the character as a “u” with modifications. Decomposition also allows for alphabetical sorting in languages where the character modifiers do not affect alphabetical order.

As discussed in “Character Normalization in IETF Protocols” (available at http://search.ieff.org/internet-drafts/draft-Düerst-i18n-norm-03.txt) by M. Düerst and M. Davis of the IETF, dated March 2000, which is also incorporated herein by reference, the wide range of characters included in the UCS may lead to different encoding sequences for the same character. These authors have identified two main kinds of these duplicate encoding equivalences: “precomposed/decomposed” equivalences (discussed above) and “singleton” equivalences. Both of these types of equivalences can be illustrated using the “A” character with a ring above (“Å”) which can be encoded with Unicode in at least three different ways, each of which will ultimately look the same to the reader.

One possible encoding for this character is the precomposed LATIN CAPITAL LETTER A WITH RING ABOVE (Unicode Code Value U+00C5, in hexadecimal notation). A second encoding is the decomposed LATIN CAPITAL LETTER A (U+0041) followed by the COMBINING RING ABOVE (U+030A) while a the third alternate encoding for this character is the ANGSTROM SIGN (U+212B). In this example, the equivalence between the first and third encodings is a singleton equivalence while the equivalence between the first and second is a precomposed/decomposed equivalence.

The Unicode Standard more specifically defines two types of equivalencies between characters: “canonical” equivalence and “compatibility” equivalence. Canonical equivalence is the fundamental equivalency between characters or sequences of characters that are indistinguishable to users when correctly rendered in text. For example, singleton equivalence is one type of canonical equivalence.

However, canonical equivalence should not be confused with language-specific “collation,” which is sometimes referred to as “alphabetization.” For example, in Swedish, “ö” is treated as a distinct letter which is collated after “z” while, in German, ö is treated as being weakly equivalent to, and collated with, the letter “œ.” In English, on the other hand, an “ö” is merely the letter “o” with a “diacritical mark” indicating a particular pronunciation. Canonical equivalence should also not be confused with the “aliasing” of canonical host names that is provided in many versions of BIND where, when a name server finds a CNAME record, it simply replaces the alias with a canonical name (in a process that is unrelated to Unicode canonical mapping) before looking up the appropriate resource record.

According to the Unicode standard, canonical equivalence is actually a subset of “compatibility equivalence.” As mentioned above, for legacy data using other character maps, the Unicode standard also provides numerous “compatibility characters” that are taken from other standards, but are really just nominal Unicode characters that are displayed in a different format. For example, a compatibility character may be equivalent to a nominal Unicode character which is displayed in a certain font. Consequently, the visual representation of these compatibility characters is only a subset of the many possible visual representations of the Unicode nominal character.

Compatibility equivalence then occurs when a character is a visually-distinguishable variant of a nominal character such as a font variant, superscript, or subscript. Thus, the nominal canonical mappings are essentially a subset of the compatibility mappings. Furthermore, replacing a character by its compatibility equivalent may result in the loss of certain information, such as formatting information, about its textual representation. Consequently, compatibility mappings generally provide the correct equivalence for only searching and sorting, rather than transcoding.

Unicode Standard Annex #15 entitled “Unicode Normalization Forms” (available at hftp://www.unicode.org/unicode/reports/tr15/), also incorporated herein by reference, defines four “normalization forms” in which equivalent strings of text can be assured to have unique binary representations. Normalization Form D (“NFD”), so-called “canonical decomposition” or “decomposed normalization,” is the process of taking a string, recursively replacing composite characters using the Unicode canonical decomposition mappings, and then putting the result in “canonical order.” A string is put into canonical order by repeatedly replacing any exchangeable pair by the pair in reversed order. When there are no remaining exchangeable pairs, then the string is in canonical order.

Note that the replacements can be done in any order. Thus, a decomposition that results from recursively applying the “canonical mappings” found in the Unicode Standard until no character can be further decomposed (and any nonspacing marks have been reordered) is referred to in the Unicode Standard as a “canonical decomposition.” As discussed above, so-called “canonical equivalence” is the fundamental equivalency between characters, or sequences of characters, in the Unicode standard.

Normalization Form KD (“NFKD”), or “compatibility decomposition,” is the process of taking a string, replacing composite characters using both the Unicode canonical decomposition mappings and the Unicode compatibility decomposition mappings, and putting the result in canonical order. Since Unicode encodes only “plain text” without any formatting information, performing a “compatibility” decomposition on a compatibility character can remove any formatting information and thus prevent the character from being re-composed, or “round-trip converted,” in a reversal of the decomposition process. Therefore, canonical decomposition is sometimes considered to be a subset of compatibility decomposition because it does not remove formatting information.

The first two normalization forms, Normalization Forms D and KD discussed above, are normalizations to decomposed characters which retain canonical or compatibility equivalence, respectively, with the original unnormalized text. Normalization Forms C (“NFC”) and KC (“NFKC”), on the. other hand, provide normalization to composite characters and are a bit more complicated because they further require canonical composition. More specifically, NFC uses canonical decomposition followed by canonical composition while NFKC uses compatibility decomposition followed by canonical composition.

With all of these normalization forms, singleton characters are replaced. Compatibility composites (characters with compatibility. decompositions) are also replaced with NFKD and NFKC. Furthermore, with NFKD, composite characters are mapped to their canonical decompositions, while with NFKC, combining character sequences are mapped to their composites, if possible. A “Normalization Demo” that contains a simple applet for demonstrating the differences among the normalization forms discussed above is available from the Unicode Consortium (at http://www.unicode.org/unicode/reports/tr15/Normalizer.html).

Canonical composition is further described in “Character Normalization in IETF Protocols” by M. Düerst and M. Davis, from the IETF, dated March 2000 (at http://Hsearch.ietf.org/internet-drafts/draft-Düerst-i18n-norm-03.txt) which is hereby incorporated by reference. In essence, canonical composition is the composing of the previously decomposed string according to the Unicode canonical mappings by successively composing each unblocked character with the last “starter.” A character is a starter if it is defined in Unicode with a combining class of zero, meaning that it acts as a base letter for determining how it will interact typographically with other combining characters. A character is blocked from the starter if, and only if, there is another starter, or another character with the same class, between the starter and the character.

“Character Normalization in IETF Protocols” (available at http://search.ieff.org/internet-drafts/draft-Düerst-i18n-norm-03.txt) by M. Düerst and M. Davis of the IETF, dated March 2000, further proposes that equivalent encodings should be dealt with in all protocols by using “early uniform normalization” according to NFC. This means that, ideally, only text in NFC will appear on the Internet and that each implementation of the Internet protocol separately implements normalization, particularly for identifiers such as URIs, domain names, e-mail addresses, etc.

More specifically, this document advises that Internet protocols should specify 1) that comparison should be carried out purely binary (after it has been made sure, where necessary, that the texts to be compared are in the same character encoding); 2) that any kind of text, and in particular identifier-like protocol elements, should be sent normalized to Normalization Form C; 3) that in case comparison fails due to a difference in text normalization, the originator of the non-normalized text is responsible for the failure; 4) that in case implementers are aware of the fact that their underlying infrastructure produces non-normalized text, they should take care to do the necessary tests and if necessary the actual normalization by themselves; and 5) that in the case of creation of identifiers, and in particular if this creation is comparatively infrequent (e.g. newsgroup names, domain names), and happens in a rather centralized manner, explicit checks for normalization should be required by the protocol specification.

Character identification is also influenced by case. The term “case” is derived from use of moveable type during the Middle Ages when the letters for each font were stored in a box with two sections (or “cases”) and where the “uppercase” was for the capital letters and the “lowercase” was for the small letters. Unicode Technical Report #21, entitled “Case Mappings” (available at http://www.unicode.org/unicode/reports/tr21/) and incorporated by reference here, discusses various case operations such as case conversion, case detection, and caseless matching. The term “downcasing” is used here to refer converting each character in a string to its lowercase.

So-called “caseless matching,” also discussed in Unicode Technical Report #21, may be implemented using “case-folding.” Case folding is the process of mapping strings to a normalized form where case differences are erased. Case-folding allows for fast caseless matches in lookups. However, caseless matching itself is only an approximation to the language-specific rules governing the strength of comparisons discussed in Unicode Technical Standard #10, entitled “Unicode Collation Algorithm,” also incorporated herein by reference (and available at http://www.unicode.org/unicodelrepprts/tr10/). This latter Report describes how to compare two Unicode strings while remaining conformant to the requirements of the Unicode Standard.

Strings which have received canonical and/or compatibility decomposition, and have been downcased, are referred to in this document here as being “canonicalized.” An expression containing only such canonicalized strings is essentially in the simplest and most significant form to which the expression may be reduced without loss of generality. Two canonicalized strings may therefore be compared with a very high degree of specificity as generally discussed in Düerst, “Requirements for String Identity Matching and String Indexing,” published by the World Wide Web Consortium on Jul. 10, 1998 (available at http://www.w3.org/tr/wd-charreq) and incorporated herein by reference.

As discussed above, character maps define not only the identity of each character in a character set and its corresponding numeric value, but also how this value is mapped, or “encoded,” into bits. The Unicode Standard endorses at least two different character encoding schemes for use with the ISO 10646 character set. These so-called “transformation formats” are referred to as “UTF-8” and “UTF-16.” In essence, these character encoding schemes are algorithms for turning code points, or “scalar values,” into the actual bits that are used by the computer. UTF-8 uses an 8-bit encoding form that is serialized to a sequence of from one to four bytes while UTF-16 uses a 16-bit encoding form that is sequenced as a series of two bytes.

Any Unicode character that is encoded in the 16-bit, UTF-16 format can be converted to the 8-bit, UTF-8 format, and back, without loss of information. However, UTF-8 has certain advantages in that the characters in Unicode which correspond to an ASCII character have the same code values as in ASCII. Consequently, Unicode characters that are encoded under the UTF-8 character encoding scheme can be used with most existing software. In this regard, a proposal entitled “Using the UTF-8 Character Set in the Domain Name System,” was published by Stuart Kwan and James Gilroy on July 2000 (at http://search.ieff.org/internet-drafts/draft-skwan-utf8-dns-04.txt) and is incorporated herein by reference.

Additional information about UTF-8 is available in RFCs 2044 and 2279. UTF-8 is essentially a transformation algorithm that accepts an integer that may range from zero up to 2,147,483,647 (2³¹-1) and outputs a string of octets that represents that integer. A decoder accepts a string generated by a UTF-8 encoding and outputs the integer that was encoded by the string. The encoder and decoder are typically iterated in order to transform strings of characters.

UTF-8 has the characteristic that any integer at or below decimal 127 (ASCII's highest code point) is transformed into a single output octet of equal value. Any integer above 127 is encoded as a sequence of octets all of which are above 127. Conventional single-null string termination is used in the UTF-8 encoding. UTF-8 transforms any of the first 128 Unicode code points into their ASCII equivalents, so that ISO-10646-1 is directly compatible with ASCII provided that code points above 127 are not used. The next 128 Unicode code points, corresponding to similarly numbered code points in ISO-8859-1, are not transformed into their ISO-8859-1 equivalents. The representation of a single ISO-8859-1 character in ISO-10646-1 is two octets in length, each octet having a value above 127. Therefore, ISO-10646-1 is not directly compatible with ISO-8859-1.

n. No Character Mapping Protocol

A particular character map, or encoding, is not currently specified in the DNS protocol, or any other protocol in the Internet suite. Instead, as noted above, most DNS implementations (including conventional BIND) follow the “preferred name syntax” in RFC 1034 where domain names are written in a small subset of the 7-bit US-ASCII character set that includes the letters A-Z, digits 0-9, and the dash. Under RFC 1034, domain names can be stored with arbitrary case, but domain name comparisons must be done in a “case-insensitive” manner. RFC 1958 similarly states that DNS names and protocol elements that are transmitted in text format should be expressed in “case-independent ASCII.”

More recently, RFC 2277 has been adopted as the best current practice, “BCP 18,” on characters sets and languages and states that new protocols should be able to use the UTF-8 “charset” which consists of the ISO 10646 character set combined with the UTF-8 character encoding scheme. In addition, BCP 18 addresses the use of other character encoding schemes for ISO 10646, such as UTF-16. However, since BCP 18 is merely a suggested practice, and not a requirement, various name servers and other host computers are likely to continue to use incompatible character maps.

o. Character Map Conversion

A “Tutorial on Character Code Issues,” is available from Jukka Korpela at the Helsinki University of Technology in Helsinki, Finland (and at www.hut.fi/u/jkorpela/chars.himl) and is incorporated by reference into this document. This tutorial mentions that various software is available for converting strings of coded characters from one code to another. For example, “Free Recode” is available from François Pinard of the Parallel Processing Laboratory in the Departement d'informatique et recherche opërationnelle (DIRO) of the Universite de Montrëal (and at http://www.iro.umontreal.ca/contrib/recode/HTML/readme.html) and is incorporated by reference here. The recode program is an application of its recode library that recognizes or produces more than 300 different character sets and transliterates files between almost any pair.

The recode library contains most code and tables from the portable “iconv” library, written by Bruno Haible and described at http://clisp.cons.org/˜haible/packages-libiconv.html. The iconv library provides an iconv( ) implementation, for use on systems which don't have one, or whose implementation cannot convert from/to Unicode. It can convert from any of the listed encodings to any other, through Unicode conversion. It has also some limited support for transliteration. For example, when a character cannot be represented in the target character set, it can be approximated through one or several similarly looking characters. Distribution of the iconv library is available on the Internet (at ftp://ftp.ilog.fr/pub/Users/haible/gnu/libiconv-1.3.tar.gz)

p. Code Conversion and the DNS Protocol

Such code conversion technology has generally not been applied to the DNS protocol. In the past, all DNS-illegal names were required to use a known character map and were then referred to a specific “pseudo-root” name server where a resource record lookup was performed based upon that character map. For example, Martin Düerst made a proposal to the Internet International Ad Hoc Committee (at www.iahc.org) entitled “Internationalization of Domain Names,” published on Jun. 10, 1996 (at http://www.iahc.org/contrib/draft-Düerst-dns-i18n-00.txt) which suggests a naming scheme that uses DNS-illegal characters and then adds a suffix (“.i”) to the encoding so as to indicate that the encoded name falls under an entirely new gTLD.

The Düerst proposal was later superseded by “UTF-5, A Transformation Format of Unicode and ISO 10646,” by Martin Düerst et al., dated Jan. 28, 2000 (at http://www.ietf.org/internet-drafts/draft-jseng-uff5-01.txt). This document describes a character encoding scheme which provides a transformed string including only alphanumeric characters from the character set including the Latin letters A-V and numerals 0-9. The Center for Internet Research at the School of Computing at National University of Singapore (at http://(www.apng.org/idns/), in cooperation with the Asia Pacific Networking Group (“APNG” at www.apng.org) claims to have implemented such a system using an “iDNS proxy server.”

In one embodiment, the scheme requires domain names to be appended with the “.idns.apng.org” subdomain name so that a mapping of the name to an IP address will be performed only by the organizations proprietary servers. In another configuration referred to as “iBIND,” i-DNS.net International Inc., of Palo Alto, Calif. (at www.i-dns.net) suggests sending DNS-illegal domain name queries one of nine “iDNS-compatible” servers where the queried domain name is converted to DNS-legal domain name using UTF-5 before the appropriate resource records are looked-up. In yet another embodiment referred to as “iClient,” the transformation is allegedly performed by the client before the query is sent to the server. i-DNS.Net Inc. has informed the IETF that it has applied for one or more patents on related technology including WO00/50966 which is incorporated herein by reference.

Similar “pseudo-root server” concepts are discussed in World Intellectual Property Organization Publication No. WO99/19814 to Pouflis in which “X-X.net” is added to the domain name so that it will sent for mapping to a specific name server. Refuah et al. have even suggested using a “translator” to help convert a variety of textual information into DNS-legal name and/or IP address information in World Intellectual Property Organization (“WIPO”) Publication No. WO 99/39280. However, the specific structure of the translator is not disclosed that publication. WO00/50966; 99/39280, 99/19814, and each of the Düerst proposals are hereby incorporated by reference into this document.

U.S. Pat. No. 6,182,148 B1 issued to Walid Tout on Jan. 30, 2001 for an application filed Jul. 21, 1999, also discloses a method and system for internationalized domain names which uses the UTF-5 transformation and is also incorporated by reference here. The domain name is converted to a standard format, such as Unicode, and then transformed to “an RFC1035 compliant” format. Redirector information is then appended to the string which identifies the delegation of authoritative root servers and/or domain name servers responsible for the domain name.

Alternatively, some form of exact string identity matching might be used to match the character string in the domain name query to a character string in a resource record as discussed in “Requirements for String Identity Matching and String Indexing” by Martin J. Düerst of the World Wide Web Consortium in a publication dated Jul. 10, 1998 (at http://www.w3.org/TRIWD-chareq). Along these same lines, WIPO Publication No. 00/13081 applied for by Basis Technology Corp. and published on Mar. 9, 2000 (claiming priority to a U.S. Patent Application filed on Aug. 31, 1998) is incorporated by reference here and discloses a system and method for storing and retrieving information based upon a string, where the string can be encoded in one of a variety of script encodings. The script encodings can be selected from a set of relevant encodings for the particular application. Legacy information is indexed by keys that are encoded in a single script and then merged or joined with additional information indexed by keys encoded in multiple additional scripts. The system and method include a domain name system that allows the creation and operation of domain names in a plurality of national encodings and further includes methods for resolving ambiguous encodings.

These conventional techniques are generally not in compliance with the DNS protocol for various reasons. For example, some require all DNS-illegal queries to be referred to a specific name server in a manner similar to the flat name space concept that was intentionally replaced by the distributed name space in current DNS protocol. Others do not allow for case insensitive matching of domain names to resource records. Furthermore, most of these methods are not very practical since they require that all queries using internationalized domain names use at least one pre-defined character map encoding that can be identified by the server.

These and other aspects of internationalized DNS are discussed in the following Internet-draft publications of the Internationalized Domain Name (“idn”) Working Group of the IETF (at http://www.ieff.org/html.charters/idn-charter.html, http://www.i-d-n.net/, and http://www.istf.org/ids.by.wg/idn .html) which are also incorporated herein by reference.

“Requirements of Internationalized Domain Names,” by James Seng and Z. Wenzel dated Jul. 6, 2000 generally describes some requirements for encoding international characters into DNS names and records. This document is intended to provide guidance for developing protocols related to the internationalized domain names. “Comparison of Internationalized Domain Name Proposals,” by Paul Hoffman, dated Jul. 12, 2000 is a companion document that compares various protocols that have been proposed for this purpose.

“RACE: Row-based ASCII Compatible Encoding for IDN,” by Paul Hoffman, dated Sep. 1, 2000, describes a transformation method for representing non-ASCII characters in host name parts in a manner that is compatible with the current DNS. It is described as a potential candidate for an ASCII-Compatible Encoding (ACE) for internationalized host names, as described in the comparison document. This method is based on the observation that many internationalized host name parts will have all their characters in one row of the ISO 10646 repertoire.

“Preparation of Internationalized Host Names,” by Paul Hoffman and Marc Blanchet, dated Jul. 6, 2000, describes a method for preparing internationalized host names for transmission on the wire. The steps include excluding characters that are prohibited from appearing in internationalized host names, changing all characters with case properties to be lowercase, and then normalizing the characters.

“Internationalized domain names using EDNS (IDNE),” by Paul Hoffman and Marc Blanchet, dated Jul. 11, 2000, describes an extension mechanism based on EDNS which enables the use of IDN without causing harm to the current DNS. IDNE allegedly enables IDN host names with as many characters as current ASCII-only host names. It also claims to fully support UTF-8 and conforms to the IDN requirements.

“Using the Universal Character Set in the Domain Name System (UDNS),” by Dan Oscarsson, dated Aug. 28, 2000, defines how the Universal Character Set (ISO 10646) can be used in DNS without extending the current RFC1035 protocol and length limits in the future.

“Architecture of Internationalized Domain Name System,” by Seungik Lee, Dongman Lee, Eunyong Park, Sungil Kim, and Hyewon Shin, dated Jul. 20, 2000, describes how multi-lingual domain names are handled in another protocol scheme for IDNS servers and resolvers.

“The DNSII Multilingual Domain Name Protocol,” by Edmon Chung and David Leung, dated Aug. 25, 2000, describes an extension of the DNS into a multilingual- and symbols-based system with adjustments made on both the client side and the server side. The DNSII protocol is intended to preserve the interoperability, consistency, and simplicity of the original DNS, while being expandable and flexible for the handling of any character or symbol used for the naming of an Internet domain.

“Internationalized Host Names Using Resolvers and Applications (IDNRA),” by Paul Hoffman and Patrik Faltstrom, dated Aug. 21, 2000, describes a mechanism that allegedly requires no changes to any DNS server and that will allow internationalized host names to be used by end users with changes only to resolvers and applications. It is intended to allow flexibility for user input and display, and to assure that host names with non-ASCII characters are not sent to servers.

“DNSII Multilingual Domain Name Resolution,” by Edmon Chung and David Leung of Neteka Inc., dated Aug. 25, 2000, outlines a resolution process that forms a framework for the resolution of multilingual domain names including a multilingual packet identifier. This document also introduces a tunneling mechanism for the short-run to transition the system through to a truly multilingual capable name space. Neteka Inc. has informed the IETF that it has applied for one or more patents on related technology.

“Simple ASCII Compatible Encoding (SACE),” by Dan Oscarsson, dated Aug. 28, 2000, describes a way to encode non-ASCII characters in host names in a way that is completely compatible with the current ASCII only host names that are used in DNS. It can be used both with DNS to support software only handling ASCII host names and as a way to downgrade from 8-bit text to ASCII in protocols.

DNSII Transitional Reflexive ASCII Compatible Encoding (TRACE), by Edmon Chung and David Leung, dated September 2000, discusses a reflexive CNAME process where non-ASCII incoming queries will be automatically CNAMEd to their ASCII counterpart without requiring an actual lookup. The REflexive CNAME (“RENAME”) process is a mechanism that attaches an incoming multilingual name to its ACE counterpart as it enters a name server.

“BRACE: Bi-mode Row-based ASCII-Compatible Encoding for IDN,” by Adam Costello, dated Sep. 14, 2000, discloses a method where ASCII letters, digits, and hyphens (“LDH”) in a Unicode string are encoded literally. Non-LDH codes in the Unicode string are then encoded using a base-32 mode in which each character of the encoded string represents five bits. Single hyphens are used in the encoded string to indicate mode changes.

“Handling Versions of Internationalized Domain Names Protocols,” by Marc Blanchet, dated Oct. 26, 2000, discusses naming conventions and record keeping issues for expected future changes to any internationalization protocols.

“Role of the Domain Name System,” by J. Klensin, dated Nov. 13, 2000, reviews the original function and purpose of the DNS and contrasts it with some of the functions that it is being forced to perform today. A framework for an alternative to placing these additional stresses on the DNS is then outlined.

“Virtually Internationalized Domain Names (VIDN),” by Sung Jae Shim of Dualname, dated Nov. 14, 2000, describes a system that uses phonemes of a local language and English as a medium for transliterating the entity-defined portions of virtual domain names in the local language into those of actual domain names in English. Dualname has also informed the IETF that it has applied for one or more patents on related technology.

“Internationalized PTR Resource Record (IPTR),” by Hongbo Shi and Jiang Ming Liang, dated September 2000, discusses a new resource record type for providing address-to-internationalized domain name mappings which includes a new field for language identification.

“Japanese Characters in Multilingual Domain Name Label,” by Yoshiro Yoneya and Yasuhiro Morishita, dated Nov. 17, 2000, discusses Japanese characters and their canonicalization rules for multilingual domain name labels.

“Proposal for a Determining Process of ACE Identifier,” by Naomasa Maruyama and Yoshiro Yoneya, dated Nov. 17, 2000, discusses problems and solutions involving the use of a prefix or a suffix as an identifier in order for multi-lingual domain names to fit within the existing ASCII domain name space.

“UTF-6—Yet Another ASCII-Compatible Encoding for IDN,” by Mark Welter and Brian W. Spolarich of WALID Inc, dated Nov. 16, 2000, discusses a transformation method which is an extension of the UTF-5 encoding that is currently deployed as part of the WALID multilingual domain name system implementation. WALID Inc. has informed the IETF that it has applied for one or more patents on related technology including WO/0056035 published on Sep. 21, 2000 which is incorporated herein by reference.

“Internationalized PTR Resource Record (IPTR)” by H. Shi, J. Liang, dated May 17, 2001, attempts to address the problem of how an IP address should be properly mapped to a set of Internationalized Domain Names. It suggests a new TYPE called IPTR using EDNSO and a mechanism to combine language information with such a mapping.

### SUMMARY

Various drawbacks of these and other conventional technologies are addressed here by providing a system, method, and logic for managing data, including a database for implementing a key value operation with a key having a predetermined encoding, and means, such as an iterative converter, for iteratively converting the key from each of a plurality of encodings to the predetermined encoding before performing the key value operation with each converted key. For example, the key value operation may be a key value insertion operation or a key value retrieval operation and preferably accommodates at least one wildcard in the database and/or the key. The system may further include means for verifying that a syntax of the converted key is valid and means for normalizing the converted key.

The encodings may be character encodings associated with one or more languages and the predetermined character encoding is preferably a universal character encoding, such as Unicode. The system may further include means for providing image data corresponding to characters resulting from these key value operations. The database may include name data, such as domain name data, and/or location data, such as IP address data and may be in the form of DNS resource records.

Also disclosed is a data server, such as a conversion server, and method and logic for implementing a data service, including means for receiving a request including an encoded portion, means for converting the encoded portion (such as a string of characters representing a domain name) of the request from each of a plurality of encodings to a predetermined encoding, and means for responding to the request based upon at least one of the converted portions having the predetermined encoding. The plurality of encodings may be chosen to correspond with a character set token or product token in the request, with a language designation by a client, or with character encodings that are directly identified by the client or user. The server may further include means for verifying a syntax of each of the converted portions and means for normalizing each of the converted portions.

The response may include one or more converted strings in the preferred encoding, image data corresponding to the characters in one or more of the converted strings, and/or character names corresponding to the characters in the converted strings. The server may be a daemon and subsumed in a NAMED portion of the Berkeley Internet Name Domain software. The server may also be configured as a file server, registration server, Network File System server, Network Information Service server, Domain Name System server, WHOIS server, File Transfer Protocol server, Hyper Text Transfer Protocol server, Simple Mail Transfer Protocol server, or a Lightweight Directory Access Protocol server.

For example, an implementation of the Domain Name System protocol will include a name server for receiving a query including an encoded domain name expression, means for iteratively converting the encoded domain name expression from each of a plurality of character encodings to a predetermined character encoding, and means for providing a response to the query based upon at least one of the converted domain name expressions having the predetermined character encoding. The server response may also include data representing a second domain name expression, such as a fully-qualified domain name expression, image data, an IP address, or an HTTP response with a redirection status code.

Each of the plurality of character encodings may be associated with one or more languages, such as the languages typically used in a particular domain or geographic region. The plurality of encodings may also be chosen to correspond to the character set and/or products tokens in an HTTP message. The Domain Name System may also include means for providing the query to the name server, such as a second name server having a wildcard resource record for directing the query to the first name server. The system may further include means for verifying a syntax of each converted domain name expression and means for normalizing each converted domain name expression.

Also disclosed here is a system for implementing the Domain Name System protocol in distributed name space that will support multiple, initially-unknown character maps, such as those with non-ASCII characters or characters that are not DNS-legal. The system may include wrapper code operating in conjunction with the Berkeley Internet Name Domain (“BIND”) implementation of the DNS protocol.

The DNS system may also. include a first module, such as a Referral Domain Name Service (“RDNS”), for determining whether one of the queried domain name expressions contains 7-bit DNS-legal character strings, 8-bit DNS-legal character strings, or another type of character strings. In this regard, RDNS may consider the character set token and/or product token in an HTTP message. The Referral Domain Name Service also determines whether the one queried domain name expression contains special character strings.

Eight-bit DNS-legal character strings are referred to a second module, or Unicode Validation and Canonicalization Engine (“UVCE”), for determining whether the 8-bit DNS-legal expression has been encoded with the Unicode character map. Prior to mapping, the Unicode Validation and Canonicalization Engine also validates, downcases, and decomposes the 8-bit, DNS-legal, Unicode expression.

The DNS system may also include a third module, or Legacy Unicodification Trial Engine (“LUTE”), for converting one of the queried domain name expressions from one character map to a universal character map, such as Unicode (preferably using the UTF-8 transformation format), prior to attempting a look-up (or other type of mapping) of the resource records for the converted expression. If the look-up attempt is unsuccessful, then the LUTE converts the queried domain name expression from another different encoding to the universal character map prior to another look-up attempt until either a successful look-up is achieved or all available conversions from various character maps to the universal character map have been attempted.

In another embodiment, the system relates to an enterprise system such as a Network Information Center including a registration web server, a relational database management system, and a system for implementing the Domain Name System (DNS) protocol in distributed name space with a name server for mapping resource records to queried domain name expressions that are encoded with different character maps.

Also disclosed here is a virtual internationalized domain name system including a URI forwarding agent, such as a URL forwarding agent, for attempting a mapping of a queried domain name expression that is encoded with an initially-undetermined character map to a corresponding DNS-legal domain name expression. The initially-undetermined character map may be a non-ASCII character map, use a binary code unit that is longer than seven bits, and/or include at least one DNS-illegal character. The system may also include a name server with a wildcard resource record for providing an IP address for referring the query to the URL forwarding agent.

The URL forwarding agent includes a first module for converting the queried domain name expression to a preferred character map prior to the attempted mapping. The preferred character map may be a universal character map, such as Unicode. In this case, the first module may also verify that the queried domain expression is encoded with a Unicode/UTF-8 character map and canonicalize the verified expression prior to the attempted mapping.

The URL forwarding agent may also include a second module for iteratively converting the queried domain name expression from various character maps to a preferred character map prior to said attempted mapping. The preferred character map may be a universal character map, such as Unicode. In this case, the first module may also verify and canonicalize the encoding of the converted expression prior the attempted mapping. When all attempted mappings are unsuccessful, the URL forwarding agent will map the queried domain name expression to a predetermined domain name expression.

A method of implementing a virtual internationalized domain name system is also provided. The method includes the steps of receiving a query with a domain name expression that is encoded with an initially-undetermined character map, and attempting a mapping of the queried domain name expression to another domain name expression which is preferably DNS-legal. The initially-undetermined character map may be a non-ASCII character map, use a binary code unit that is longer than seven bits, and/or include at least one DNS-illegal character. During the receiving step, the queried domain name expression is preferably received from a client that has been provided with an IP address from a participating name server in response to finding a wildcard resource record in a zone file of the name server.

The method may also include the step of verifying whether the queried domain expression is encoded with a Unicode/UTF-8 character map and then canonicalizing the verified expression prior to the attempted mapping. In addition, the method may also include converting the queried domain name expression to a universal character map before the attempted mapping step. The universal character map may be Unicode, in which case, the converted domain name expression may also be verified, and the verified expression canonicalized prior to said attempted mapping.

After an unsuccessful verification, the queried domain name expression is converted from another character map to a preferred character map before the next attempted mapping. The preferred or predetermined character map may be a universal character map, such as Unicode. In this case, the first module may also verify and canonicalize the encoding of the converted expression prior the attempted mapping. When all attempted mappings are unsuccessful, the URL forwarding agent will map the queried domain name expression to a predetermined domain name expression.

Also provided here is a virtual internationalized domain name system, including a name server with a wildcard resource record for referring a queried domain name expression that is encoded with an initially-undetermined character map. For example, the participating name server may include a wildcard resource record with an IP address of a URI forwarding agent. The initially-undetermined character map may be a non-ASCII character map, use a binary code unit that is longer than seven bits, and/or include at least one DNS-illegal character.

Another method of implementing a virtual internationalized domain name system is also provided here. This method includes the steps of receiving a query with a domain name expression that is encoded with an initially-undetermined character map, and referring the query to a forwarding agent for mapping the queried domain name expression to another domain name expression. The initially-undetermined character map may be a non-ASCII character map, use a binary code unit that is longer than seven bits, and/or include at least one DNS-illegal character. The other domain name expression is preferably DNS-legal.

In yet another embodiment, the URI forwarding agent is arranged to map a queried domain name expression that is encoded with an initially-undetermined character map to a corresponding DNS-legal domain name expression. The queried domain name expression may include at least one DNS-illegal character. The initially-undetermined character map may be a non-ASCII character map and/or use a binary code unit that is longer than seven bits.

The URI forwarding agent may further include one or more modules for making multiple mapping attempts. A first module verifies that the queried domain expression is encoded with a Unicode/UTF-8 character map and canonicalizes the verified expression prior to a first attempt at said mapping. A second module converts the queried domain name expression to a preferred character map prior to a second attempt at mapping. For example, the preferred character map may be a universal character map, such as Unicode with the UTF-8 transformation format. When the second attempted mapping is unsuccessful, the URI forwarding agent maps the queried domain name expression to a predetermined domain name expression where, for example, information for registering the domain name may be presented.

Also described here is a general system for accommodating multiple character encodings in a keyed database retrieval and insertion operation without having prior knowledge of the particular character encoding that is used for each key. The general system can be broadly described with regard to four main components. The first component is a database for implementing a key-value retrieval using a pre-determined character encoding that is preferably a universal character encoding such as Unicode. The second component is a key validator for determining whether the key follows an acceptable pattern in the character encoding. The third component is an encoding converter that transforms text to and/or from the predetermined character encoding, preferably with integral validation that the input text is actually a valid source character encoding. The fourth component is an iterator that performs the conversion, validation, and database lookup components in an iterative fashion.

Optional components of the system include a key normalization mechanism which may be combined with the key validation component. A pattern matching mechanism (which is an extension to the database component) by which multiple distinct keys are made to correspond to the same value data may also be included. A resolution mechanism may be provided for using interactive dialogue to resolve ambiguous or failed identifications of the character encoding of a key. An image conversion mechanism may be provided for converting text in some character encoding to an image in some graphical format, and a constraining mechanism may be provided for constraining the set of character encodings that are under consideration by specifying the language of the text.

This latter system generally operates as follows. A key is received and passed to the key validator. If the key is determined to be valid, then a database lookup is attempted, and a reply is generated. The reply will contain either data from the database, or a failure message when no data was found. If the key is not valid, then control passes to the iterator.

The iterator has an encoding pointer that is initialized to the first character encoding in a prioritized list of encoding conversions that are to be attempted. A conversion of the key is then attempted from the current character encoding (i.e., the character encoding currently identified by the pointer) to the first encoding in a prioritized list. If the conversion succeeds, then the resulting converted key is validated and a database lookup is attempted with that new key.

When data is found, a conversion of the data to the current encoding is also attempted. If the conversion of the data from the first character encoding to the current encoding succeeds, then a reply is generated containing the conversion of the data that has been found in the database, and the process completes. If any of these steps fails, then the iterator encoding pointer is incremented to the next encoding in the list, and the process is repeated with the attempted conversion from the next encoding in the list of prioritized encodings. The process is then repeated until there is a successful conversion, or the encoding list is exhausted so as to generate a reply containing a failure message is generated.

In one embodiment, the general system may be subsumed in an otherwise conventional DNS service whereby DNS records can be keyed on, and can contain, characters which are not part of the US-ASCII character map. In this embodiment, the DNS server's key-value lookup table is used as the database and a simple test is performed to determine if the query consists entirely of only valid ASCII character patterns before the query reaches the principal key validator. If valid ASCII character patterns are found, then the query is immediately looked up without reaching the principal validator.

A key normalization system, that is tightly integrated with the principal key validator may also be included for all queries that will reach the principal validator so that normalization is necessary. The server's built-in lookup table system ignores ASCII case. Since case is the only character attribute in ASCII that is affected by normalization, it is not necessary to perform key normalization for queries that consist entirely of valid ASCII character patterns. A pattern matching mechanism may also be tightly integrated with the servers built in table lookup system.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram of a data managing system.

FIG. 2 is a schematic diagram of a communication system illustrating various implementations of the data managing system of FIG. 1.

FIG. 3 is a flow diagram illustrating the architecture, operation, and/or functionality of one of a number of possible embodiments of the data management facility of FIG. 1.

FIG. 4 is a flow diagram illustrating the architecture, operation, and/or functionality of another possible embodiment of the data management facility of FIG. 1.

FIG. 5 is a flow diagram illustrating the architecture, operation, and/or functionality of yet another possible embodiment of the data management facility of FIG. 1.

FIG. 6 is a flow diagram illustrating the architecture, operation, and/or functionality of yet another possible embodiment of the data management facility of FIG. 1.

FIG. 7 is a flow diagram illustrating the architecture, operation, and/or functionality of one of a number of possible embodiment of yet another embodiment of the data management facility in FIG. 1.

FIG. 8 is a screen shot of a user interface device.

FIG. 9 is a flow diagram illustrating the architecture, operation, and/or functionality of one of a number of possible embodiments of the data management facility of FIG. 1.

FIG. 10 is a group of resource records for use by the participating server shown in FIG. 11.

FIGS. 11 and 12 are schematic diagrams illustrating the interaction between the devices shown in these FIGs.

FIG. 13 is a group of resource records for use in the URL forwarding agent shown in FIG. 11.

FIG. 14 is a flow diagrams illustrating the architecture, operation, and/or functionality of yet another possible embodiment of the data management facility of FIG. 1.

FIGS. 15 and 16 are related flow diagrams illustrating the architecture, operation, and/or functionality of yet another possible embodiment of the data management facility of FIG. 1.

### DETAILED DESCRIPTION OF THE PREFERRED EMBODIMENTS

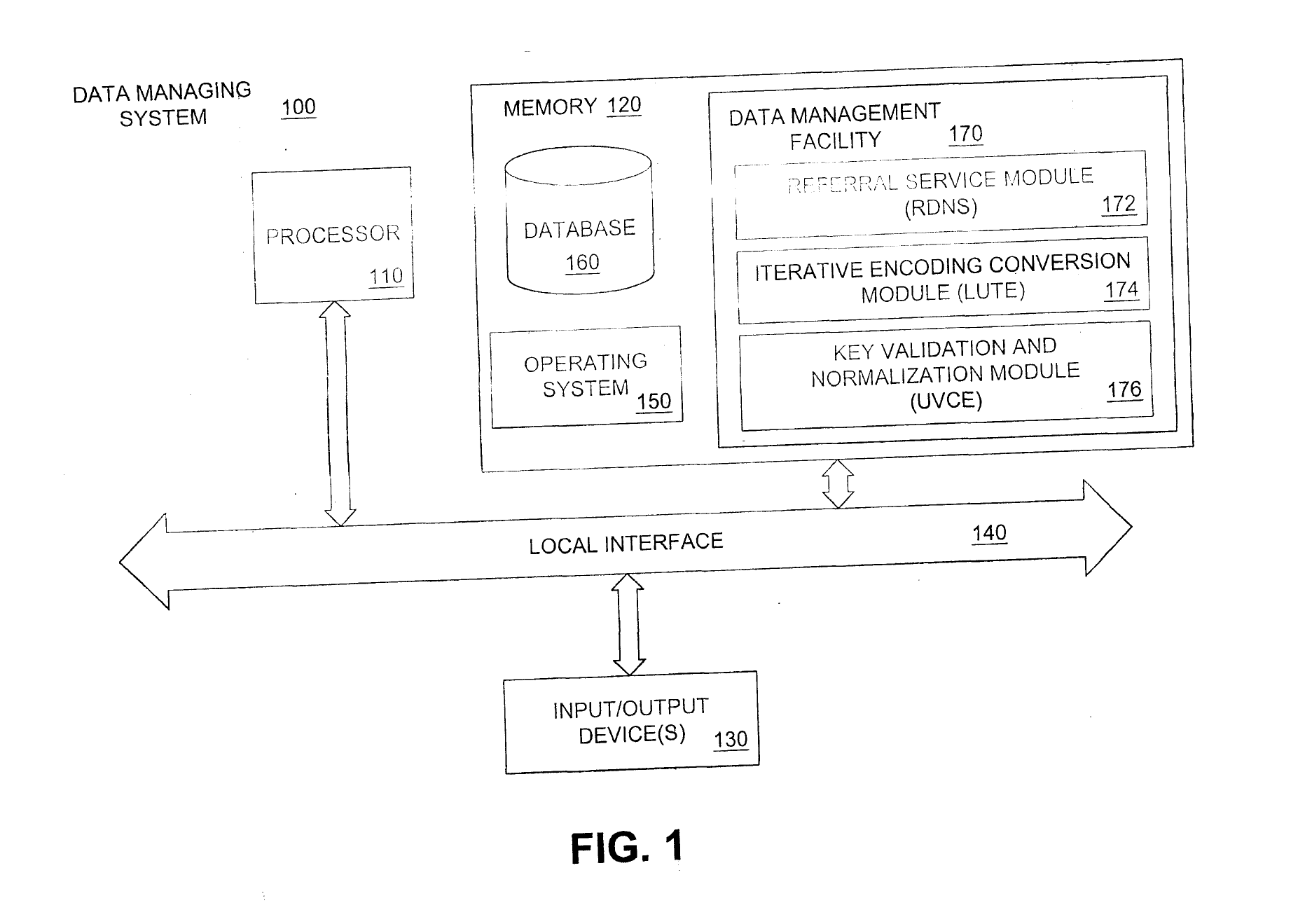

FIG. 1 is a schematic diagram of certain components in a data managing system 100. The data managing 100 may be implemented in a wide variety of electrical, electronic, computer, mechanical, and/or manual configurations. However, in a preferred embodiment, the system 100 is at least partially computerized with various aspects of the system being implemented by software, firmware, hardware, or a combination thereof.

In terms of hardware architecture, the preferred data managing system 100 includes a processor 110, memory 120, and one or more input and/or output (“I/O”) devices 130. The processor 110, memory 120, and I/O devices 130 are communicatively coupled via a local interface 140. The local interface 140 may include one or more buses, or other wired or wireless connections, as is known in the art. Although not shown in FIG. 1, the interface 140 may have other communication elements, such as controllers, buffers (caches) driver, repeaters, and/or receivers. Various address, control, and/or data connections may also be provided with the local interface 140 for enabling communications among the various components of the system 100. The input/output devices 130 may include network connections, such as Internet gateways and/or routers.

The memory 120 may have volatile memory elements (e.g., random access memory, or “RAM,” such as DRAM, SRAM, etc.), nonvolatile memory elements (e.g., hard drive, tape, read only memory, or “ROM,” CDROM, etc.), or any combination thereof. The memory 120 may also incorporate electronic, magnetic, optical, and/or other types of storage devices. A distributed memory architecture, where various memory components are situated remote from one another, may also be used.

The processor 110 is preferably a hardware device for implementing software that is stored in the memory 120. The processor 110 can be any custom-made or commercially available processor, including semiconductor-based microprocessors (in the form of a microchip) and/or macroprocessors. The processor 110 may be a central processing unit (“CPU”) or an auxiliary processor among several processors associated with the computer 100. Examples of suitable commercially-available microprocessors include, but are not limited to, the PA-RISC series of microprocessors from Hewlett-Packard Company, U.S.A., the 80x86 and Pentium series of microprocessors from Intel Corporation, U.S.A., PowerPC microprocessors from IBM, U.S.A., Sparc microprocessors from Sun Microsystems, Inc, and the 68xxx series of microprocessors from Motorola Corporation, U.S.A.

The memory 120 stores software in the form of instructions and/or data for use by the processor 110. The instructions will generally include one or more separate programs, or modules, each of which comprises an ordered listing of executable instructions for implementing one or more logical functions. In the particular example shown in FIG. 1, the software contained in the memory 120 includes a suitable operating system (“O/S”) 150, along with a database 160 and a data management facility 170 including one or more modules as described in more detail below.

The operating system 150 implements the execution of other computer programs and provides scheduling, input-output control, file and data management, memory management, communication control, and other related services. Various commercially-available operating systems 160 may be used, including, but not limited to, the Windows operating system from Microsoft Corporation, U.S.A., the Netware operating system from Novell, Inc., U.S.A., and various UNIX operating systems available from vendors such as Hewlett-Packard Company, U.S.A., Sun Microsystems, Inc., U.S.A., and AT&T Corporation, U.S.A.

The database 160 will include one or more structured sets of persistent data along with associated with software to update and query the data. For example, a simple database could be arranged as a single file containing many records, each of which contains the same set of fields where each field may be a certain fixed width. The database 160 will also include various conventional database management programs that support query languages and report writers that allow users to interactively interrogate the database and analyze its data. The database may be local, remote, or distributed in arrangement. The database may also be deductive hierarchical, functional, object-oriented, or relational in configuration.

Records in the database 160 are preferably retrieved, inserted, or otherwise operated on or manipulated using a key value. Depending upon the configuration of the database, the key may be one of the fields, e.g. a column if the database is considered as a table with records being rows. Alternatively the key may be obtained by applying some function, e.g. a hash function, to one or more of the fields. The set of keys for all records forms an index. Multiple indexes may be built for one database depending on how it is to be searched.

As discussed in more detail below, the data in the database 160 may contain name data, such as domain name data, and/or location data, such as IP address data, that may be arranged in the form of DNS resource records. However, the database 160 may be organized in a variety of other ways, and/or contain a variety of other data. The database 160 may also be configured as a separate, remote or local, hardware component of the system 100.

In the architecture shown in FIG. 1, the data management facility 170 may be a source program (or “source code”), executable program (“object code”), script, or any other entity comprising a set of instructions to be performed as described in more detail below. In order to work with a particular operating system 150, any such source code will typically be translated into object code via a conventional compiler, assembler, interpreter, or the like, which may (or may not) be included within the memory 120. The various modules of the data mapping facility may be written using an object oriented programming language having classes of data and methods, and/or a procedure programming language, having routines, subroutines, and/or functions. For example, suitable programming languages include, but are not limited to, C, C++, Pascal, Basic, Fortran, Cobol, Perl, Java, and Ada.

When the data management facility 170 is implemented in software, as is shown in FIG. 1, it can be stored on any computer readable medium for use by, or in connection with, any computer-related system or method, such as the data managing system 100. In the context of this document, a “computer readable medium” includes any electronic, magnetic, optical, or other physical device or means that can contain or store a computer program for use by, or in connection with, a computer-related system or method. The computer-related system may be any instruction execution system, apparatus, or device, such as a computer-based system, processor-containing system, or other system that can fetch the instructions from the instruction execution system, apparatus, or device and then execute those instructions. Therefore, in the context of this document, a computer-readable medium can be any means that will store, communicate, propagate, or transport the program for use by, or in connection with, the instruction execution system, apparatus, or device.

For example, the computer readable medium may take a variety of forms including, but is not limited to, an electronic, magnetic, optical, electromagnetic, infrared, or semiconductor system, apparatus, device, or propagation medium. More specific examples of a computer-readable medium include an electrical connection (electronic) having one or more wires, a portable computer diskette (magnetic), a random access memory (“RAM”) (electronic), a read-only memory (“ROM”) (electronic), an erasable programmable read-only memory (“EPROM,” “EEPROM,” or Flash memory) (electronic), an optical fiber (optical), and a portable compact disc read-only memory (“CDROM”) (optical). The computer readable medium could even be paper or another suitable medium upon which the program is printed, as the program can be electronically captured, for instance via optical sensing or scanning of the paper, and then compiled, interpreted or otherwise processed in a suitable manner before being stored in the memory 120.

In another embodiment, where any portion of the data management facility 170 is at least partially implemented in hardware, the system may be implemented using a variety of technologies including, but not limited to, discrete logic circuit(s) having logic gates for implementing logic functions upon data signals, application specific integrated circuit(s) (“ASIC”) having appropriate combinational logic gates, programmable gate array(s) (“PGA”), and/or field programmable gate array(s) (“FPGA”).

Once the data managing system 100 is started, the processor 110 will be configured to execute instructions in the operating system 150 that is stored within the memory 120. The processor 110 will also receive and execute further instructions in the data mapping facility 170 so as to generally operate the system 100 pursuant to the instructions and data contained in the software and/or hardware as described below.

In the embodiment illustrated in FIG. 1, the data management facility 170 is configured with three modules. However, the facility may also be provided in other configurations, and with any number of modules. As discussed in more detail below, the referral service module 172 directs traffics and/or certain queries for further processing without completing the query for that key value. The iterative encoding conversion module 174 includes a converter and an iterater for iteratively converting a key in a query from each of a plurality of encodings to a (predetermined) preferred encoding before performing the key value operation with each converted key. The converter may also normalize the converted key value.

The encodings are preferably character encodings with the preferred encoding being Unicode. However, a variety of other encodings may also be used. The optional key validation and normalization module 176 verifies that the syntax of the converted key is valid in the preferred encoding and/or normalizes the key according to the requirements of the preferred encoding. When applied to the Domain Name System with Unicode as the predetermined encoding, the modules 172, 174, and 176 shown in FIG. 1 may be referred to as the Referral Domain Name Service (“RDNS”), Legacy Unicodification Trial Engine (“LUTE”), and Unicode Verification and Canolicalization Engine (“UVCE”), respectively.

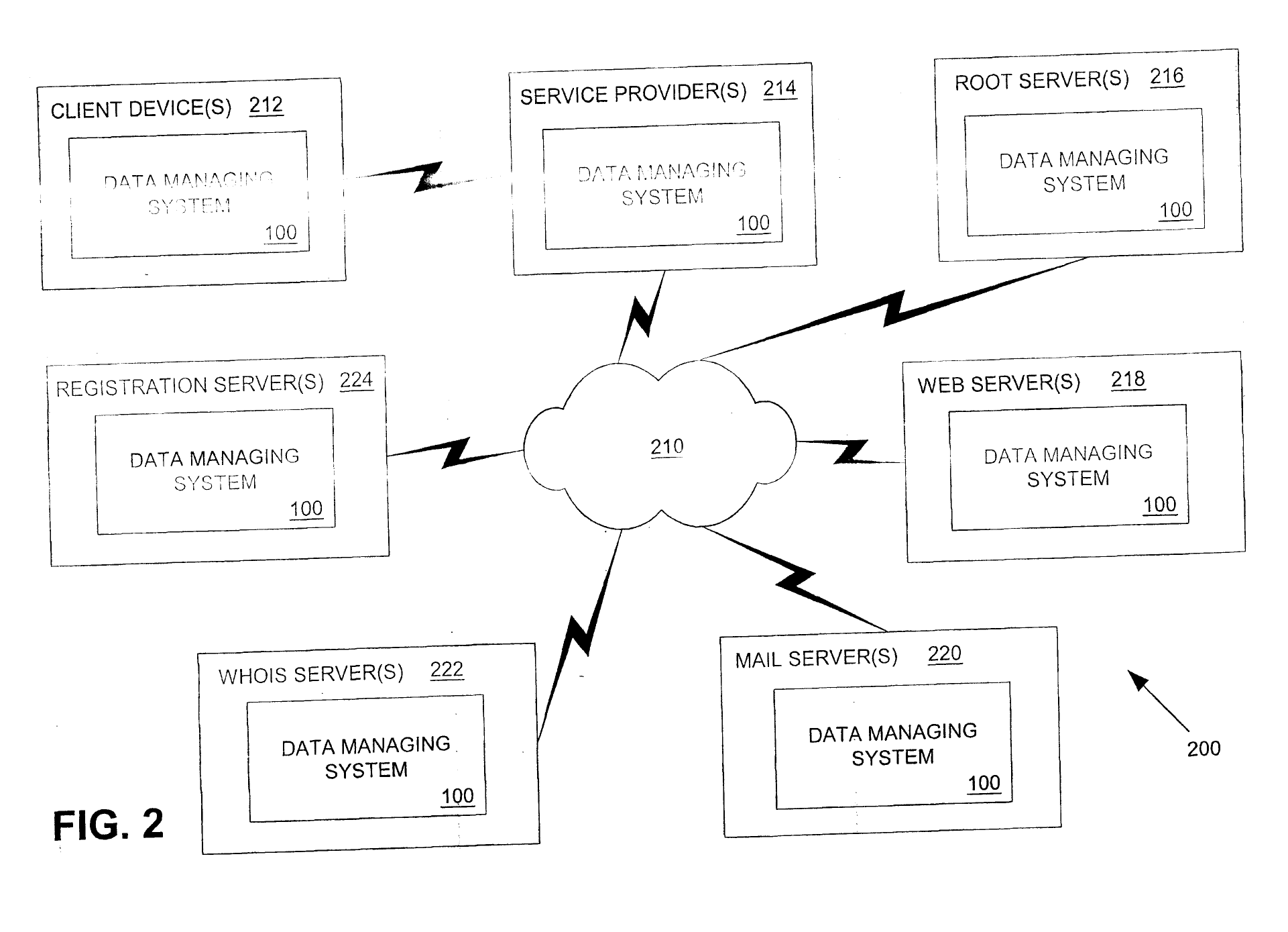

FIG. 2 illustrates a communication system 200 in which various embodiments of data managing system 100 may be implemented. The communication system 200 may include client devices 212, service providers 214, root servers 216, web servers (such as DNS servers, URL forwarding agents, and conversion servers) 218, mail servers 220, WHOIS servers 222, and a communications network 210. Service providers 214 may facilitate communication between client devices 212 and root servers 216, web servers 218, mail servers 220, WHOIS servers 222, and registration servers 222 via the communications network 210.

The communications network 210 may be any type of communication network employing any network topology, transmission medium, or network protocol. For example, communications network 114 may be a local area network (LAN), a metropolitan area network (MAN), a wide are network (WAN), any public or private packet-switched or other data network, including the Internet, circuit-switched networks, such as the public switched telephone network (PSTN), wireless networks, or any other desired communications infrastructure.

As will be understood by one of ordinary skill in the art, the precise configuration of client devices 212, service providers 214, root servers 216, web servers 218, mail servers 220, WHOIS servers 222, and registration servers 222 is not critical. The important aspect is that the various embodiments of data managing system 100 may be implemented by, or in connection with, client devices 212, service providers 214, root servers 216, web servers 218, mail servers 220, WHOIS servers 222, and registration servers 222.

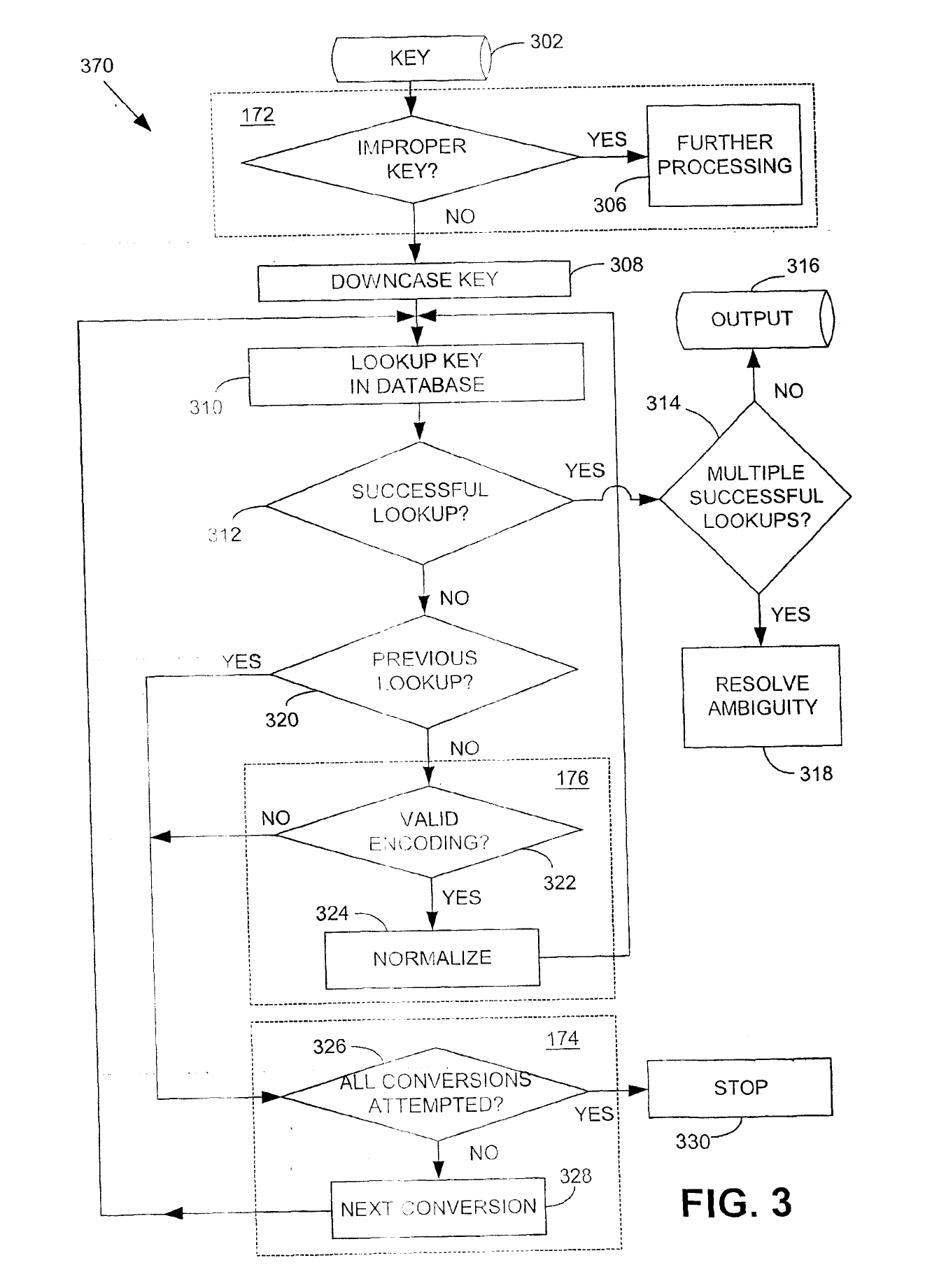

FIG. 3 is a flow diagram for one embodiment of the data management facility 170 shown in FIG. 1. More specifically, FIG. 3 shows the general architecture, functionality, and operation of a software system 370 for implementing the referral service module 172, iterative encoding conversion module 174, and key validation module 176. However, as noted above, a variety of other computer, electrical, electronic, mechanical, and/or manual systems may be similarly configured.

Each block in FIG. 3 (and the other flowcharts presented here) represents an activity, step, module, segment, or portion of computer code that will typically comprise one or more executable instructions for implementing the specific logical function(s). It should also be noted that, in various alternative implementations, the functions noted in the blocks will occur out of the order noted in the FIGs. For example, multiple functions in different blocks may be executed substantially concurrently, in a different order, incompletely, and/or over an extended period of time, depending on the functionality involved. Various steps may also be skipped or completed manually.

The data management facility 370 starts with a key 302 provided as part of a database query or other key value operation associated with the database 160. The key will have an initially-undetermined encoding, such as a US-ASCII, Unicode, or EUC-TW (Taiwanese) character encoding. The optional referral service module 172 performs gross analysis at step 304 and “traffics” queries containing certain keys for further processing at step 306. For example, certain keys may not be suitable for use with the database 160 without further processing. The string is then optionally downcased, if necessary, at step 308 and a database lookup is attempted at step 310. If the lookup is deemed successful at step 312, then a check will be made as to whether any other lookup attempts (discussed below) were also successful at step 314. If no other lookup attempts were successful, then the retrieved data or other output 316 from the database 160 is provided. Alternatively, a mechanism may be provided for resolving the ambiguity associated with multiple successful lookups at step 318. For example, multiple database retrievals may be provide to the client and/or displayed to the user for selection of the appropriate data.

If the lookup step 312 was not successful, then the key 302 is sent for further processing by the key validation module 176 and iterative encoding module 174. However, on subsequent passes, if it is determined that the key 302 has been previously looked up at step 320, then further processing by the key validation module 176 may be skipped and the key 302 sent directly to the iterative encoding conversion module 174 as illustrated in FIG. 3.

At step 322, an analysis is performed to determine whether the encoding of the key 302 in a preferred encoding is valid. For example, the analysis may consider whether the encoding of the key 302 follows an acceptable syntax in the preferred encoding format. For keys containing encoded characters, this will preferably include a determination as to whether the key follows a valid Unicode syntax, such as by examining the validity of the Unicode code points. Of course, other encodings, or portions of encodings, such as just a character encoding form, may be considered instead of an entire Unicode character mapping such as compression encodings, and security encodings or encryptions. If the syntax is acceptable, then the key is assumed to have the preferred encoding and is optionally normalized at step 324 before being sent back for another lookup. The normalization step 324 may alternatively be performed before validity checking step 322.

If this second lookup attempt is also unsuccessful, then the key is sent to the iterative encoding conversion module 174. The module 174 includes an encoding converter that converts the key 302 from one of a plurality of encodings to the preferred encoding. For example, the key 302 (with an unknown character encoding at this point in the system 370) may be converted from EUC-TW (Taiwanese) to Unicode at step 328 before another lookup is attempted at step 310. A reverse conversion (not shown) may also be provided where, for example, the Unicode key is converted back to EUC-TW (Taiwanese) and compared with the original key as a further check on the conversion process.

As noted above, the module 174 also includes an iterator (or iterater) for choosing another encoding from which to convert the key to Unicode before sending the key back for another lookup. For example, on the second pass through module 174, the key 302 could be converted from EUC-JS (Japanese) to Unicode before being sent for another attempted lookup. Of course, any number of character (or other) encodings in addition to EUC-TW and EUC-JS will also be attempted until it has been determined that all conversions have been attempted at step 326 and the process stops at step 330. If there are no successful lookup attempts, then an error message (not shown) may be provided.

The encodings that are used for these conversions may be explicitly or implicitly identified by the client or user submitting the key. 302. For example, the key may be submitted as part of and HTTP protocol message including a character set token and/or product token from which the appropriate character encodings can be deduced. Various other protocols could also be defined to include similar character encoding and/or product identifiers.

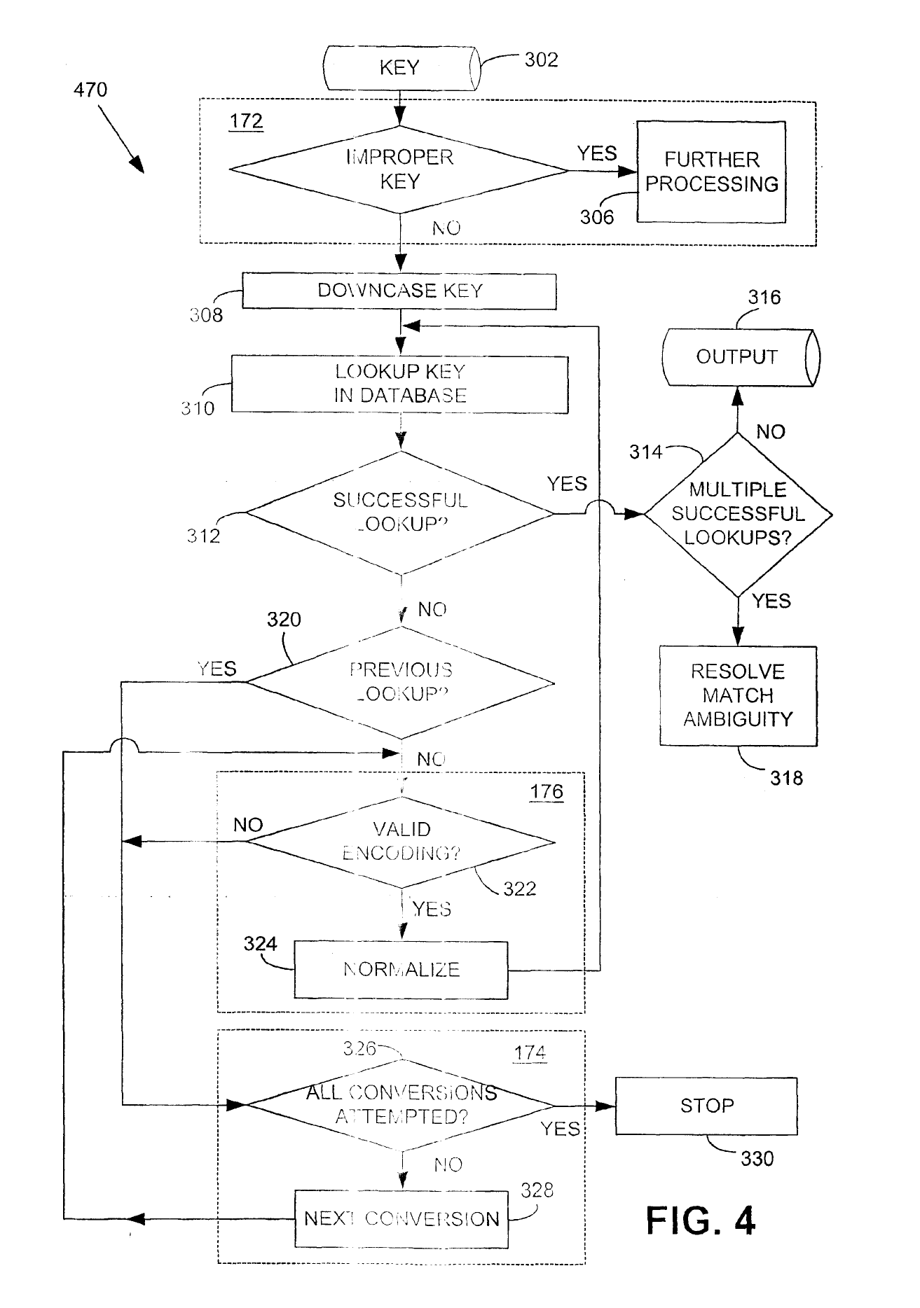

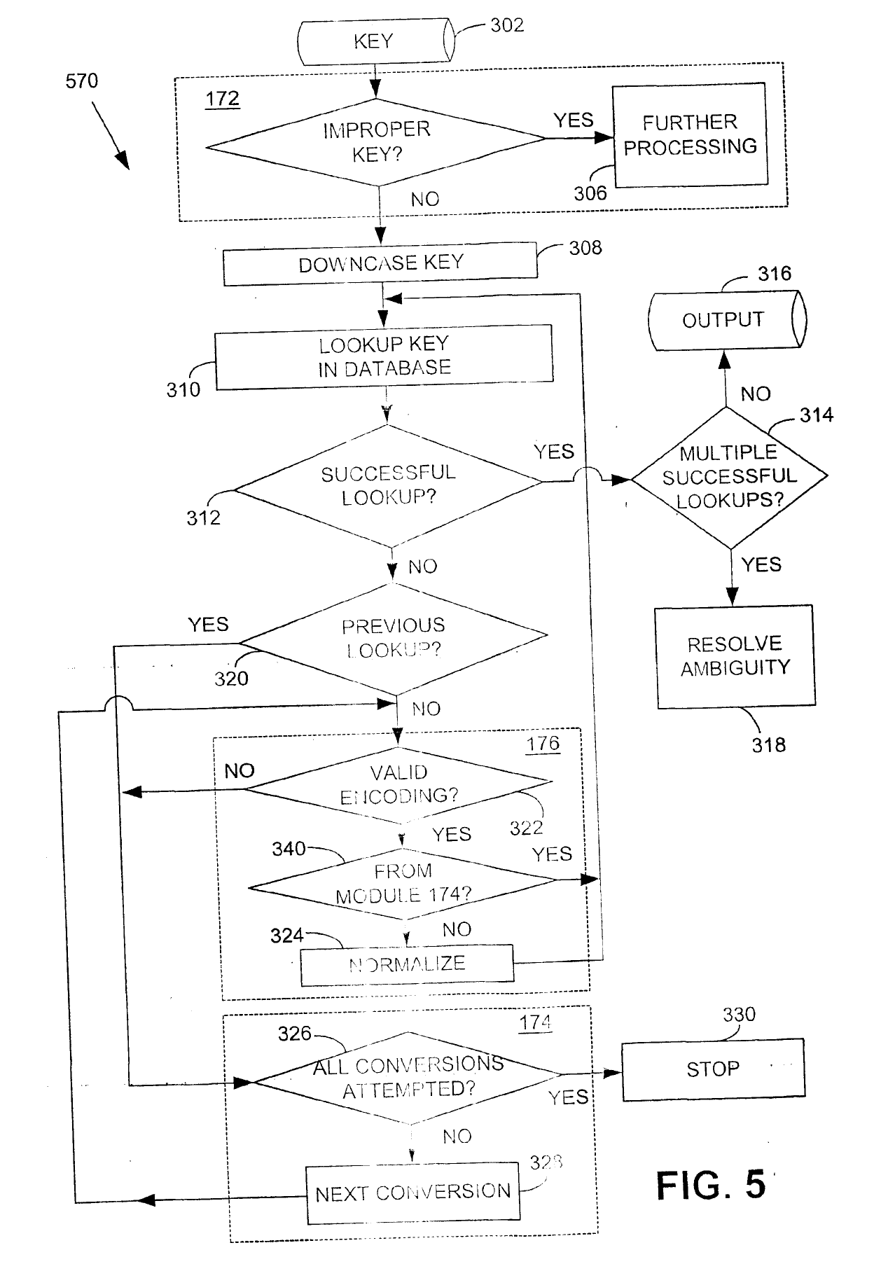

FIGS. 4 and 5 illustrate alternative embodiments 470 and 570 of the system 370 that is shown in FIG. 3. In FIG. 4, each converted key is sent from the iterative encoding conversion module 174 to the key validation module 172 before being normalized at step 324 sent for lookup at step 310. Of course, when the conversion step 328 results in a converted key with an invalid syntax for the resulting preferred encoding, then no lookup is required for the invalid key and the next conversion will be attempted until all conversions have been attempted at step 326.

Since the encoding conversions provided at step 328 of the iterative encoding conversion module 174 in FIGS. 3 and 4 will preferably provide in a normalized conversion, it is not necessary to again normalize the converted keys in the key and normalization validation module 176. Therefore, in the embodiment shown In FIG. 5, an additional step 340 is added to determine if the key originated from the iterative encoding conversion module 174 in order to bypass the normalization step 324 under those circumstances.

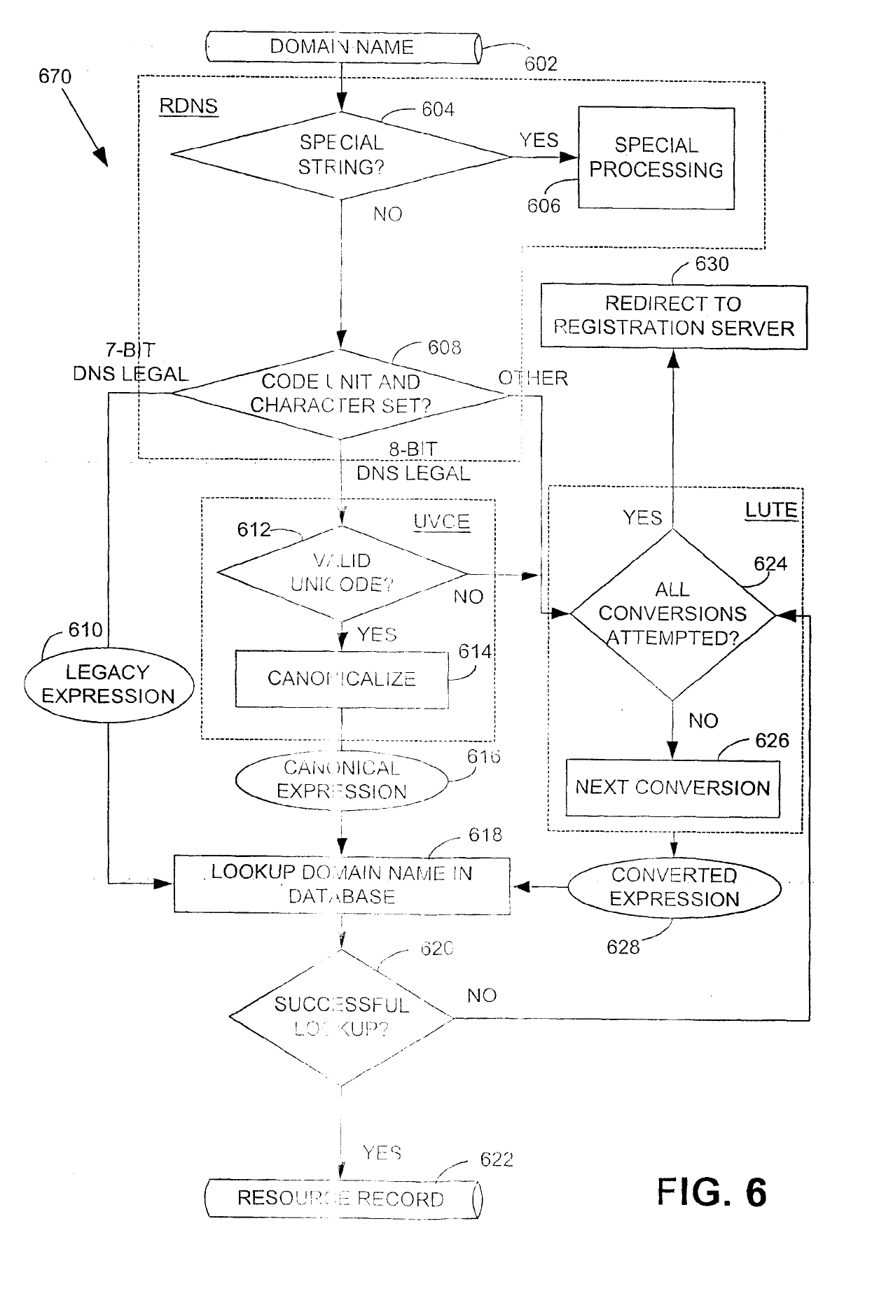

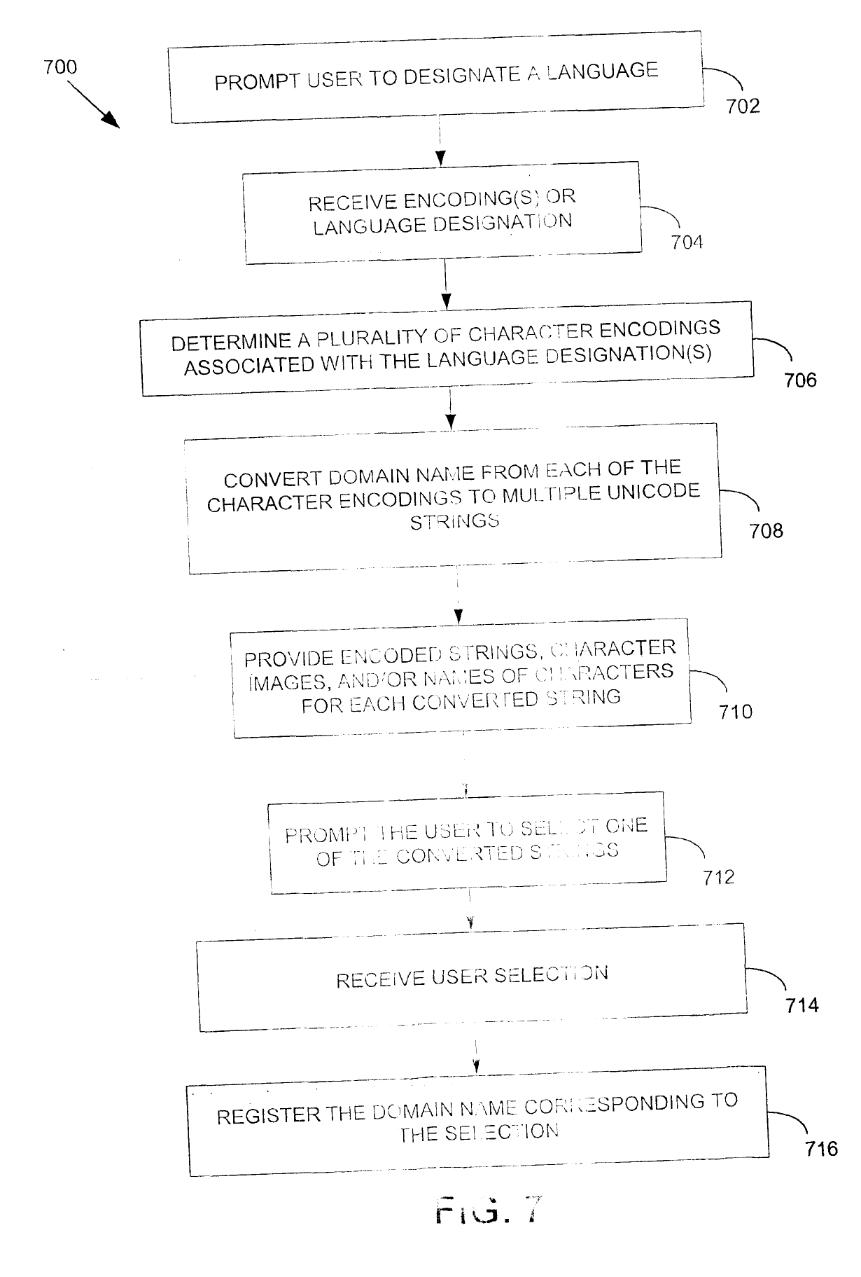

FIG. 6 illustrates another system 670 for implementing the data management facility 170 (FIG. 1) that is particularly useful for mapping names to locations, and, in particular, domain names to resource records including IP addresses. This embodiment is particularly useful with the BIND version 8.2.2-P5 software which is distributed by the Internet Software Consortium. However, other versions of BIND from the Internet Software Consortium, or other distributors of conventional software implementations of the DNS protocol, may also be used. BIND includes a database with resource records for implementing key value retrievals for keys including only DNS-legal characters with the US-ASCII encoding.

Referring to FIG. 6, RDNS is optional wrapper code which resides inside, or is called by, the main lookup function of BIND. This wrapper code acts as an interface between BIND and the UVCE and LUTE modules. More particularly, RDNS performs gross analysis and “traffics” queries for further processing depending upon the results of a string analysis of the query. A queried domain name expression, username name expression, hostname expression, or other expression 602 including a domain name that is encoded with an “initially-undetermined” character map is received by RDNS from the resolver. The character map which was used to encode this queried domain name expression is initially-undetermined because it is not specifically identified by the client making that request. Consequently, it is unknown or unspecified to the system at this point, but will eventually be determined.

RDNS acts as a query filter which preferably classifies the queried expression into one of four groups: 1) a special string, 2) a 7-bit DNS legal string, such as one encoded with US-ASCII 3) an 8-bit DNS legal string, such as one encoded with ISO 8859, or 4) an illegal string that might include DNS-illegal characters and/or be encoded with Unicode. A special string is one that is identified for special processing such as immediate delegation to another server or to another module on the same server. For example, the special string is identified at step 604 and referred to an external module for further processing at step 606. If the special string is problematic (such as one with unclean characters) and therefore delegated to another module (not shown) on the same server, it could receive some additional preliminary processing before being returned to RDNS. Alternatively, the other module may simply cause an error or warning message to be issued. The string may also be delegated to another server by RDNS if it falls within a subzone for which authority has been delegated to another name server in the same domain. This latter configuration allows groups of resource records for a particular zone to be divided and conveniently stored on different machines for ease of administration and possibly faster lookups.

The remaining strings are optionally filtered by code unit length and/or character set at step 608 using functions that are derived from previous distributions of the name server in BIND. As shown in FIG. 6, legacy expressions 610 include seven-bit, DNS-legal strings and are sent for mapping to the appropriate resource record using conventional, or “legacy,” lookup technology provided by existing implementations of the DNS protocol such as existing BIND software. The eight-bit DNS-legal strings are passed to the UVCE for further analysis. The 8-bit DNS-legal strings may also be further grouped by the RDNS into ISO-8859-1 and/or Unicode encodings and flagged accordingly for further processing by the UVCE or LUTE modules module. The remaining “other” strings are likely to be “DNS-illegal” strings and are passed to LUTE, if enabled, or delegated to a LUTE-enabled server upon synthesis of an appropriate name server (“NS”) record. The raw domain name 602 is also saved for use in the reply.

In general terms, UVCE is a key validator for determining whether the key follows an acceptable pattern for a universal character encoding, such as Unicode. More particularly, as shown in FIG. 6, UVCE first checks whether the string is a valid Unicode/UTF-8 encoding at step 612 by confirming the integrity of the UTF-8 encoding and the validity of all Unicode code points that appear in the input string. However, as noted above other character map encodings besides Unicode, including other universal character sets and/or character encoding schemes, may also be used. The universal character encoding may also be constructed by combining a set of distinct character encodings and then using tagging, or another scheme, to identify the encoding that is used in each portion of text.

If DNS restrictions are flagged (as called by the name server providing the domain name) UVCE also confirms at step 612 that only “clean” characters appear in the input, i.e., there are no “unsafe” or “reserved” characters that are particularly troublesome when used in domain names as is generally described in RFCs 1738 and 1630. Most punctuation and all whitespace are rejected when DNS restrictions are flagged. The validation stage also computes the size of the output string so that if conversion (downcasing and/or decomposition) is necessary, the output string can be allocated with a single call to the memory allocator.

More particularly, any combination of Unicode characters will be validated at step 612 except for control characters, whitespace, and unassigned, private, and surrogate code points. Letters, letter modifiers, and decimal and alphabetic numbers, are always permitted. A mid-dot is permitted in non-label boundary positions. Non-spacing marks and spacing-combining marks are permitted anywhere except at the start of a label. Punctuation is prohibited, except that dash and period are permitted as provided for in conventional DNS implementations. Symbols, fractions, control characters, separators, whitespace, and surrogate, private, and unassigned code points, are also prohibited. Valid hostname labels are limited to 63 octets with a maximum domain text length of 255 octets and maximum packet size of 512 octets in order to conform with legacy DNS systems. However, since Unicode is a variable length character map, with many scripts being encoded by two or three octets per character (or four per surrogate pair), it is expected that these label lengths may be expanded and could be easily accommodated by modifications to the system disclosed here.

UVCE also normalizes the key at step through, for example, downcasing any uppercase characters in the string to lower case and/or decomposing the characters into their constituent elements. Once the string has been validated as a proper Unicode/UTF-8 encoding; it is “canonicalized” (i.e. downcased and fully decomposed) at step 614 using compatibility decomposition and/or canonical decomposition. Canonicalization is preferably performed by recursively downcasing and performing a single stage of decomposition/normalization mapping, in that order, until further recursion has no effect, or performing any operation with the same result.

This preferably results in downcased Normalization Form KD (compatibility decomposition). Optionally, Normalization Form KC can then be computed from Form KD by performing canonical composition, i.e. recombining character sequences that can be represented with generic combined forms (combined forms whose decompositions are unqualified in the Unicode character table). By using form KC internally, the name server can realize modest memory savings, in exchange for a modest computational expense.

Compatibility decomposition (Form KD) is preferred because, in contrast to canonical decomposition, all characters which differ only in typographic nuance, are treated as equivalents. This is precisely the transformation that is preferred for the DNS name space. For example, superscript and subscript forms are simply converted to their ordinary forms using Form KD. Thus, once canonicalized in this manner, “emc2.nu” will refer to the same domain, regardless of whether the client submits the ‘2’ character in plain or superscript form.

The resulting canonicalized, or canonical, expression 616 is then sent for lookup at step 618. If the lookup is successful at step 620, then a resource record 622 is identified and/or returned at step 622. Resource records may be returned using the same character map as the queried domain name expression or another character map. If an attempt to look up the canonical expression 616 fails, then an error message (not shown) may be issued indicating that no matching records have been found.

However, such unsuccessful lookups of canonical expressions (or 7-bit DNS legal strings) 616 at step 618 are preferably referred to LUTE for further processing. In general terms, LUTE includes an encoding converter for transforming a key in one encoding to another encoding that is preferably a universal character encoding. LUTE also includes an iterator for controlling the database, key validator, and encoding converter to perform in an iterative fashion using a plurality of different character encodings.

As shown in FIG. 6 LUTE is the final step for query categorization and lookup. It performs an iterative process of converting a DNS-illegal string (including DNS-illegal characters and/or a non-ASCII encoding) from an initially-unknown encoding to a universal character map that can represent most useful scripts at step 626. If Unicode is used as the preferred universal character map in LUTE, then each converted expression 628 may also be validated and canonicalized using the UVCE module. After any validation and/or canonicalization by UVCE, a lookup is attempted at step 618 with each converted domain name expression 628. If successful, an optional reverse conversion may be performed (not shown) on the retrieved records 622 in order to confirm that they can be converted to match the character map encoding that was used by the client.

After an unsuccessful lookup (or reverse conversion), another conversion is performed from the next character encoding to the preferred universal encoding at step 626. If the next lookup with the next converted expression 628 is unsuccessful, then the original expression is converted from a subsequent character map encoding to Unicode (or other universal character map) and another look up is attempted. The conversion and look up process is then repeated until all encodings have been attempted at step 624 in an order that is set at runtime and can be updated at any time while the server is running. If all lookups are unsuccessful, then client making the original query may be referred to another server at step 630, such as a registration server for registering the domain name 602.

A typical DNS resolution using the system shown in FIG. 6 with BIND can also be described as follows. First, the resolver library receives a hostname and record type to be resolved. The hostname is then validated, to assure that it contains no invalid character patterns and does not exceed any length constraints. When the server is asked to resolve a hostname that contains an invalid character pattern, it returns an ns_r_nxdomain “Name error” message immediately, and does not attempt a resolution. If there are no error messages, a query packet is constructed from the hostname as it was received by the library. The packet is then transmitted to the recursing name server at which the client is currently pointed according to the resolver library configuration (e.g., localhost). The packet is then received and deconstructed by the recursing server.

The recursing server extracts and canonicalizes the queried hostname from the packet. It then attempts a lookup in the name server's table of records using the computed canonical form and the extracted target record type. If any matching records are found, a reply packet is constructed and returned to the client, which then deconstructs the reply and supplies the information in an appropriate form to the agent that invoked the resolver library. The uncanonicalized form of the queried hostname is preferably used in constructing the reply packet so that the client is certain to see a bitwise match between the expected and actual key in the reply.

As with conventional DNS systems, if no matching records are found, a “treewalk” is performed in order to identify another name server for answering the hostname query. The identified name server is then queried for the requested data. In all cases, the domain text that is used for constructing query packets is preferably uncanonicalized even though canonicalization might result in no changes to the query. Once this is complete, processing returns to constructing and returning a reply packet to the client. Any errors will thus occur under the same conditions as conventional DNS systems and result in termination of the resolution process and presentation to the client with an error message.

As noted above, the system is preferably based on BIND version 8.2.2-p5 running under Solaris with the several additional components including a validating UTF-8 coder/decoder. In a particular configuration, a set of utility library routines are provided such as a Unicode character table loader, a set of character categorizers and other attribute tests, replacements for the C library str[n]casecmp( ) calls, and various other support routines. A Unicode/UTF-8 UVCE generating Normalization Form KD and a Unicode character table generator utility program are also provided in the preferred configuration.

The preferred configuration will also include alterations to various resolver libraries in conventional BIND. For example, “Res_hnok( )” is made to operate with UVCE and “resolv.conf” is enhanced to add a switch for enabling the process. A character table path specification for use when the table is not in the usual location is also added. Alterations to the name server are also made in connection with “nlookup( ),” “ns_req( ),” “ns_resp( ),” and others while a various utility client alterations are made to cause verbatim, rather than escaped, output of the UTF-8 transformed octets.

The behavior of the system is preferably set at runtime in the startup configuration file (“named.conf” for BIND ver. 8) on a general, or zone by zone, basis. If an RDNS module is included, all RDNS name daemons will typically have RDNS enabled, but only some will have LUTE enabled. For example, front-line root name servers would preferably have only the UVCE enabled, with the RDNS referring LUTE queries to a LUTE-enabled server via synthesis of, and reply with, an appropriate name server (“NS”) resource records.

More particularly, when the name server acts as a caching intermediary between the client and an authoritative name server, LUTE preferably takes place within the caching server, rather than in the authoritative server. In this case, a slightly simplified version of the LUTE algorithm is used where the iterative conversion trials stop with the first conversion that results in a clean domain name. This converted domain name is then resolved by retrieving matching records, if any, from the local cache. If the cache does not yet contain any information about the queried domain name, then the converted domain name expression is resolved by requesting the information from an authoritative name server in an operation known as “recursion.”

The list of candidate character maps to be used when a name server acts as a cache, and its order of precedence, can (and usually will) be tailored by trimming out those character maps that are not used by clients of the caching server, and by ordering those that remain so that more-used encodings precede less-used encodings in the LUTE conversion process. The name server can also be configured so that, when a domain name query resolved through recursion does not unambiguously identify a suitable character encoding for use in the reply, a predetermined character encoding will be used in replies whenever conversion is possible.

This system allows for scalability since new character map conversions can be added to LUTE as they are developed. The system also allows the most common and computationally fastest encodings to be placed earlier in the iterative rotation so as to maximize efficiency. Furthermore, if two encodings are sufficiently similar that categorization is ambiguous, then a favored conversion can be made first so as to minimize spurious name server responses such as falsely successful look ups. Various algorithms for automatically updating the conversion order may also be implemented.

The system also allows both the DNS query and reply to contain DNS-illegal characters from a universal character set such as Unicode. It “deterministically” accommodates the universal character map encoding in a predictable and repeatable fashion. It also “heuristically” accommodates other character maps in a manner which does not necessarily produce the expected and desired result. Moreover, the system deterministically ignores variations of character form in a queried domain name expression so that all such forms can be treated equally.

The system may be operated as part of an enterprise system, such as a domain name registry business operated by an NIC. In this embodiment, the system will include a registration web server, relational database management system, and a middleware “glue” scripting system such as Cold Fusion by Allaire. General information about middleware is available in RFC 2768. The NIC will use these components to maintain a master database for, among other things, implementing a key value insertion and retrieval operations using a universal character encoding such as Unicode.

Each record in the registration database is typically stored in three forms. First, each domain name is stored, verbatim, as it was submitted in the application for registration. The character encoding is then copied verbatim from the HTTP submission portion of the application, and/or optionally confirmed from a dialogue with the customer, before it is stored in a second column in the database. This form is used solely for reference purposes, for example, when a user reports a problem indicating that the name was improperly encoded. In a third column, the domain name is recorded with any compatibility characters, and any upper and lower features, in what is sometimes referred to as “colloquial Unicode,” or the ISO 10646-1 “presentation form.” This presentation form is used for the zone and name daemon configuration files used by BIND.

The information in the third column is then downcased and fully decomposed (including any canonical and/or compatibility decomposition) and placed in a fourth column which is used to check for the availability of a domain during registration. If Normalization Form KC is used, rather than Form KD, then canonicalization of conventionally presented (composed lowercase) hostname text will not result in any significant change in process size as compared to keying records on distinct canonical forms with Form KD. Thus, Form KC is very attractive, despite the additional computational load it involves over Form KD. Furthermore, in installations where zone files will not be manually edited, it may be more efficient to mechanically pre-canonicalize all zone data and dispense with the presentation form.

The information in the fourth column is also extracted to build configuration files for other services that perform such look ups, such as, “WHOIS” services. Similar domain name applications that would not collide using the information in the third column, such as those having only case or decomposition differences, will collide when compared with information from the fourth column, and will be properly rejected.

The system can also be operated as a zone file filter by passing the domain name of the zone through the UVCE as it appears in the configuration file. Any name that is not an 8-bit, DNS-legal, valid Unicode expression is kept in verbatim form for presentation and canonical form for lookup. Then, for each record in the corresponding zone file, the record can be rejected if it is not a DNS-legal Unicode expression. For records which are not rejected, if the “left hand side” contains non-ASCII characters, they are passed through the UVCE to compute the canonicalized expression for lookup. The verbatim (non-canonicalized version) may then be preserved for presentation purposes.

The character encoding of the domain name in a request to a name server is generally not identified by the client making that request. Consequently, any server that incorporates the invention shown in FIG. 6 can be used to find the corresponding resource records for DNS-illegal domain names, if they exist, in the database files of that server. However, the client making the request may not be using the appropriate character map to decode any textual portions of the server's reply. This can be particularly problematic for WHOIS servers where the encoding used for the domain name information in the reply will significantly alter how that information is expressed in textual format by the client.

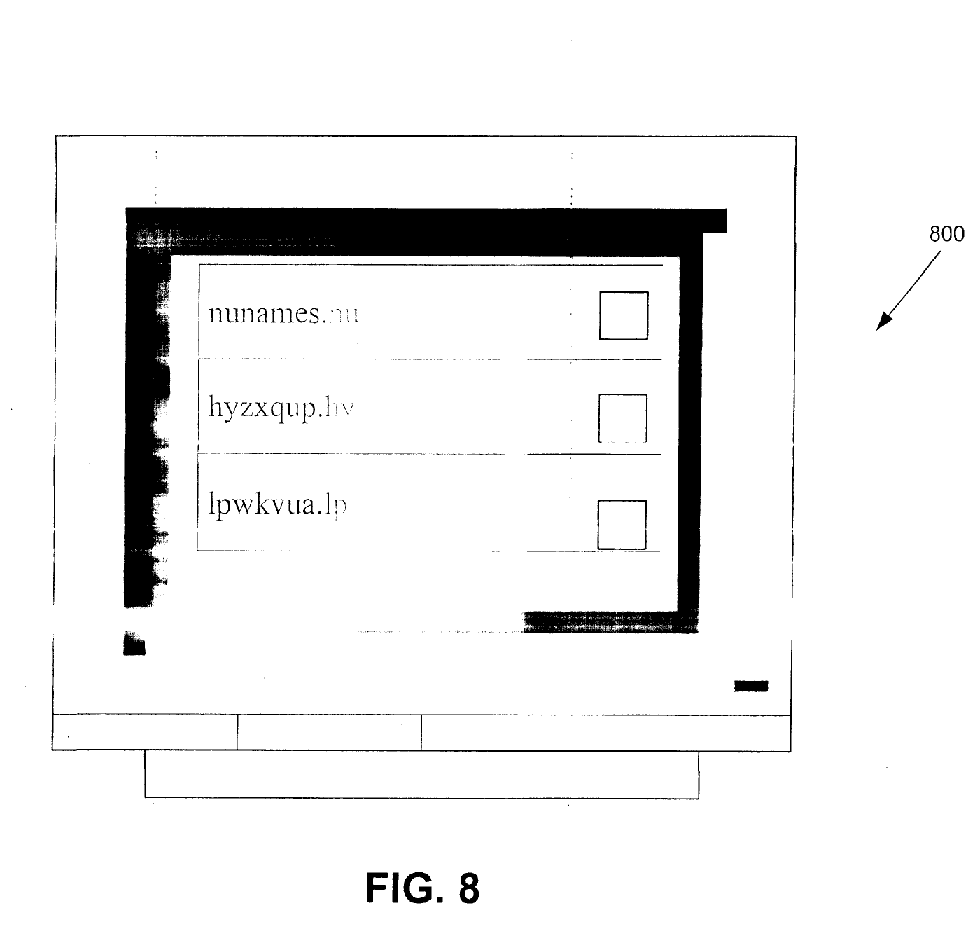

Therefore, a response from an improved WHOIS server will preferably include multiple encodings of the same domain name as shown in the screen shot illustrated in FIG. 8. In addition, images of the glyphs that correspond to the characters in the domain name and/or names of the characters may also be provided. Any image information will then be presented as an image file (or link to an image file) in JPEG, PDF, and/or other image file formats. In this way, the information that is returned by the WHOIS server will be independent of the character map decoding being used by the client making the request. Alternatively, an image may be presented to the user instructing them how to change the settings on their web browser in order to view the WHOIS server's response with the appropriate character map. The WHOIS server may also be arranged to use a particular character map (such as Japanese shift JIS) in its response and/or to provide instructions for changing browser settings in a particular language (such as Japanese) depending on the location of the client making the request (such as a destination domain name including the “.jp” country code).

For WHOIS and other server queries that request a domain name which is not available, the server will preferably respond with a proposal for registering the name. This registration proposal may ask the user to specify the character map with which for the requested domain name registration is encoded. Alternatively, the unregistered domain name may be provided to the user in multiple character encodings, or with character images or names and the user will be asked to chose one encoding for registration.

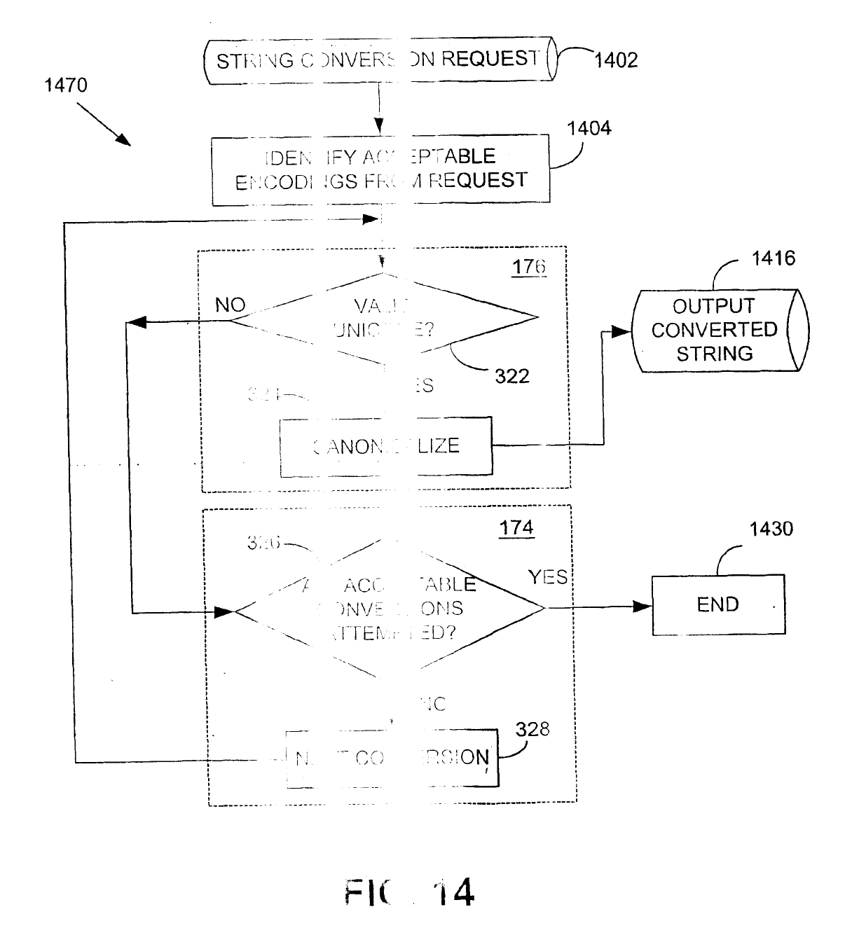

FIG. 7 illustrates a system 700 for limiting the number of possible encodings that must be considered by the user in order to resolve this ambiguity. At step 702, the client or user may optionally be prompted to designate a language(s) or character encoding(s) which is received by the server at step 704. At step 706, the sever identifies one or more character encodings corresponding to that language, such as US-ASCII and Unicode for English. Alternatively, the appropriate character encoding(s) may be explicitly or implicitly determined from a character set designation, product designation, or other designation used by the protocol being implemented by the user or client. At step 708, the requested domain name is converted from each of the plurality of encodings to multiple Unicode strings as described below with regard to FIG. 14.

The encoded string(s), character images, and/or names of the characters in each strings are then provide to the client or user at step 710. If multiple strings are provided, the user or client will resolve any ambiguity. For example, each character in the domain name string may be presented as a separate image and/or with a corresponding name for the particular glyph represented by the image. The user may also be presented with options (such as a drop down box or link) for changing a particular character image to one that is phonetically, textually, contextually, positionally, or otherwise related to the first character shown in the registration proposal. Once the user selection is received at step 714, or the ambiguity is otherwise resolved, the domain name may be registered at step 716. Once the appropriate character string is identified by the user, additional registration instructions may be provided as an image and/or text which uses the character encoding corresponding to the character encoding in the domain name being applied for.

As noted above, when separate encoded strings are provide to the client they will appear as shown in FIG. 8, since the client 800 will typically operate properly with only a single character map. Consequently, strings that are encoded with any other character map will appear garbled when decoded by the client 800. For example, as shown in FIG. 8, only the top domain name is not garbled because it has been provided using the same character encoding as the client. Alternatively, all of the domain name choices shown in FIG. 8 may. displayed correctly by providing the user with image data for each character in each of the domain name choices as shown in FIG. 7 at step 710. The user can then be more easily prompted to select one of the groups of character images at step.

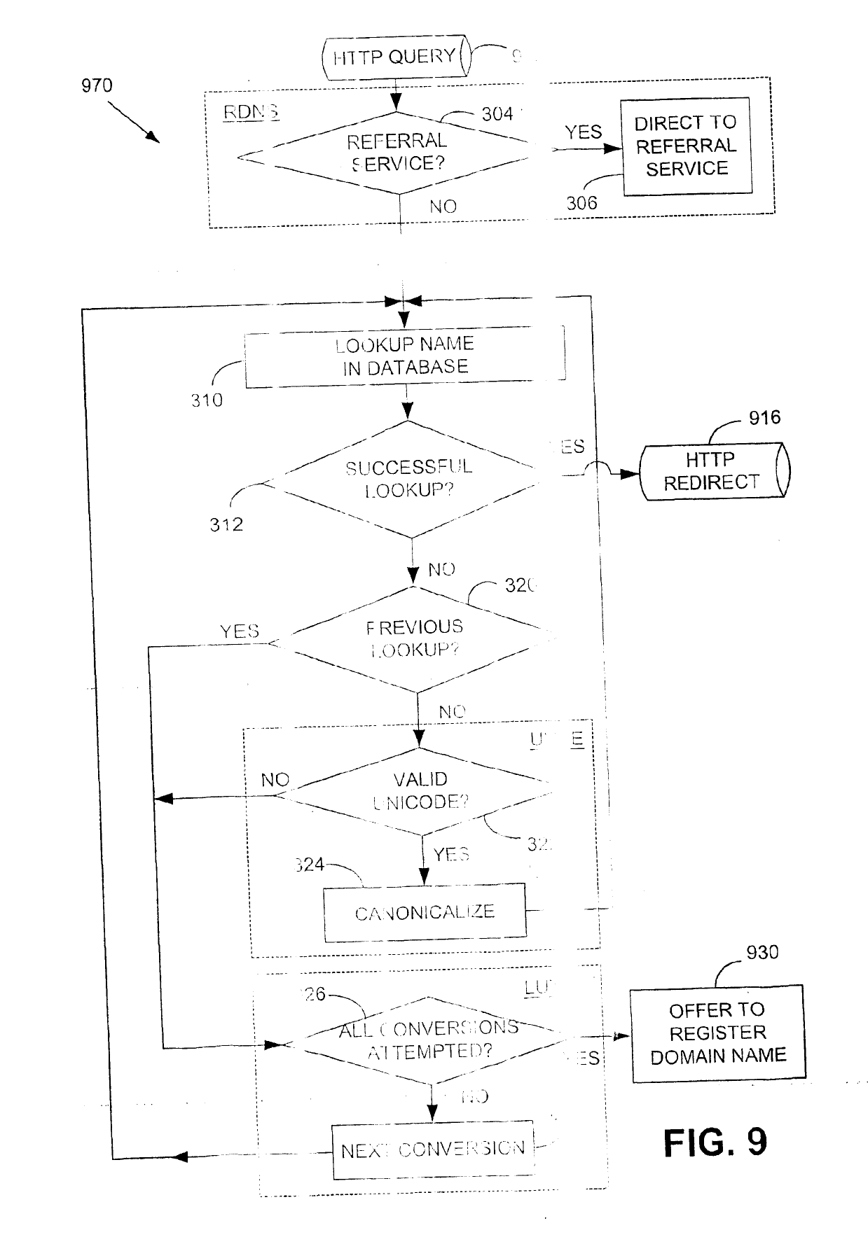

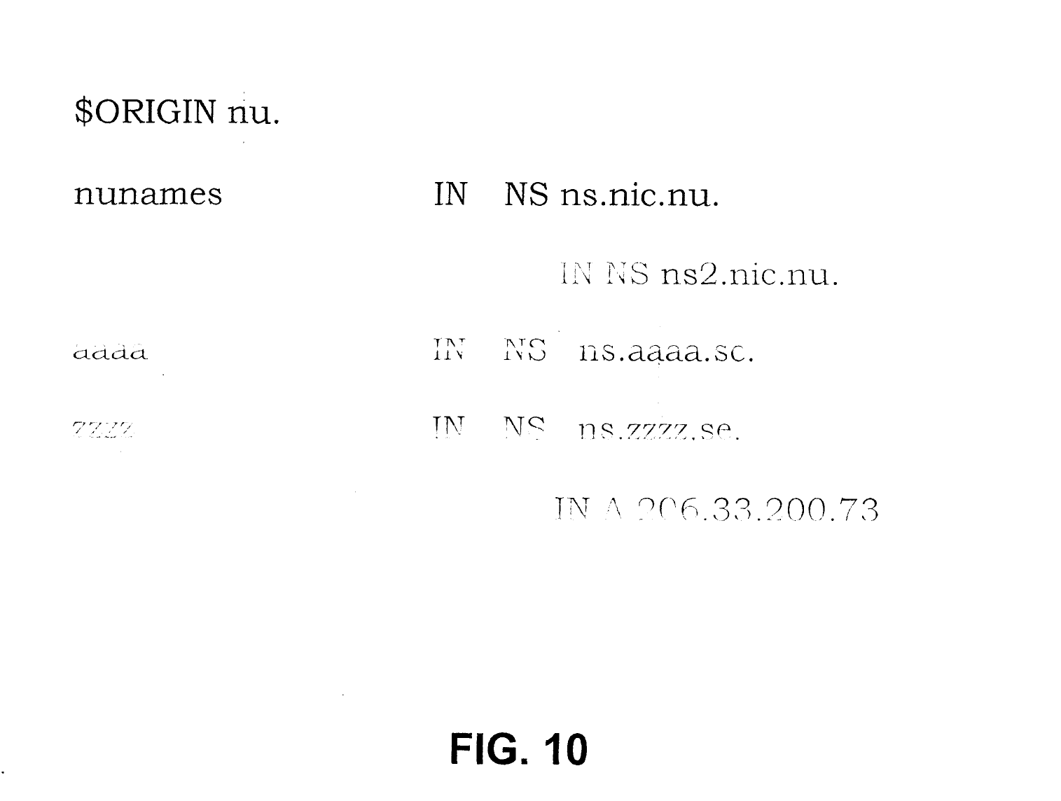

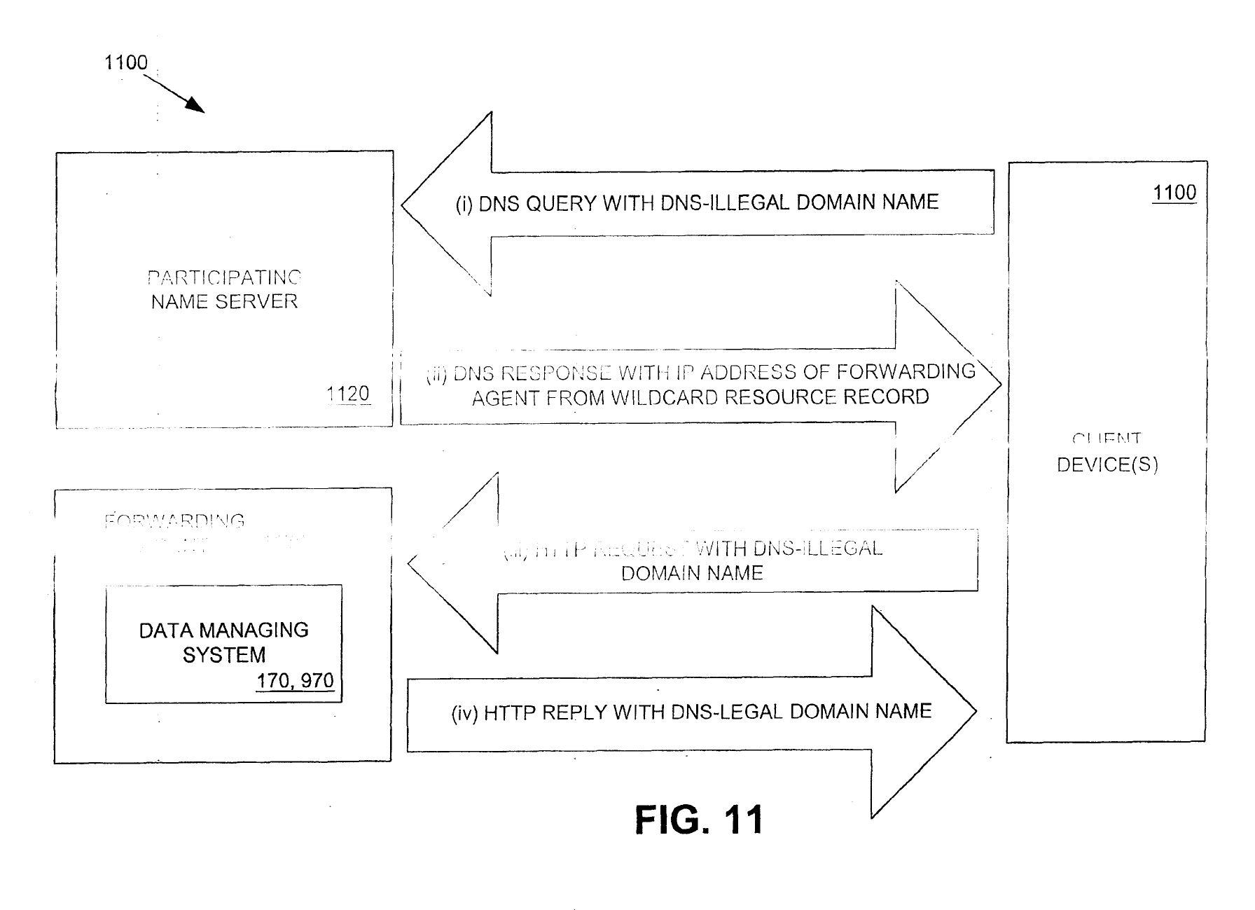

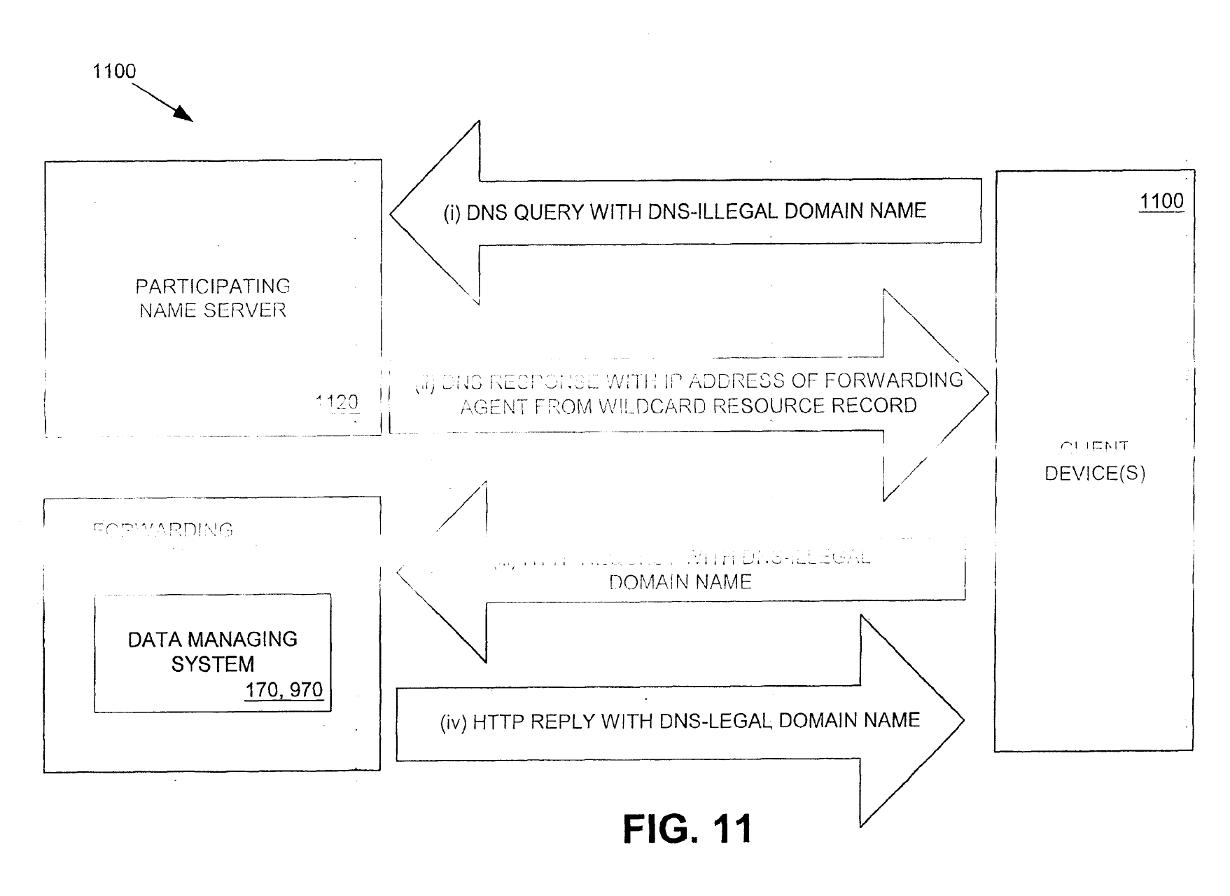

FIGS. 9-13 illustrate various aspects of another embodiment of the technology described above that does not require the zone files in every name server to include domain names with DNS-illegal characters or characters maps with eight-bit code units. Instead, the master zone files for each participating name server 1120 (FIG. 11) on the Internet are only slightly modified to include a wildcard resource record as shown in FIG. 10 and discussed below.

A wildcard is a special character or character sequence which matches any character in a string comparison, like ellipsis (“. . .”) in ordinary written text. In Unix filenames ‘?’ matches any single character and ‘*’ matches any zero or more characters. In regular expressions, ‘.’ matches any one character and “[. . .]” matches any one of the enclosed characters. Although described here with regard to wildcards located in the resource record database, the system may also be configured to accommodate wildcards in the query. Authoritative name servers that do not wish to support internationalized domain names with non-ASCII character maps and/or DNS-illegal characters can continue to operate without making any changes by simply not including the wildcard resource record. It is therefore much easier to convince innovative network administrators to implement the second embodiment of the invention than the previously discussed DNS embodiment.

In FIG. 10, the “$ORIGIN nu.” record is a control entry, or directive, that resets the current origin so that lower records in the database with owner names that do not end in a dot (“.”) are treated as if they were appended with “.nu.” The second and third records are name server records indicating that there are two name servers, “ns.nic.nu” and “ns2.nic.nu,” for the zone “nunames.nu.” In this example, these particular servers are being operated by the Network Information Center (“NIC”) that acts as the official registrar for all top-level domain names ending in “.nu.” These servers will also handle registrations for other domain names that are expressed in non-ASCII character maps, with code units that are longer than seven bits, and/or include at least one DNS-illegal character. However, multiple registrars may also be accommodated, for example, by their implementation of the first embodiment of the invention discussed above and/or by using additional wildcard resource records in the participating name server 1120 (FIG. 11). Load balancing may also be accomplished by providing different wildcard resource records for each zone.

The next group of records in FIG. 10 represent other subdomain name servers that might be registered with the NIC for the .nu domain. For example, authority for the “aaaa.nu” subdomain is delegated to the name server at the address ns.aaaa.se. Consequently, queries concerning hosts in the aaaa.nu subdomain will be delegated to the name server at ns.aaaa.se.

The last record on the last line of FIG. 10 is a wildcard address record that covers all other domain names ending in “.nu.” This record will cause any domain ending in “.nu” that does not match with any specific resource records for this origin to be forwarded to the host at IP address 206.33.200.73. This includes any domain name queries that use 7-bit DNS-illegal characters, characters with 8-bit code units, and/or any other non-ASCII character map. Therefore, such a typical domain names do not have to be added to the zone files in the conventional name servers that are currently operating on the Internet. For the resource records shown in FIG. 10, the host at IP address 206.33.200.73 is the URI forwarding agent 1130 shown in FIG. 11. Although this embodiment is described with respect to a particular type of URI, namely a URL, forwarding agents for other types of URIs, besides URLs, could also be used. The forwarding agent 1130 could also be located at a different IP addresses if the wildcard record in the referring server was modified accordingly.

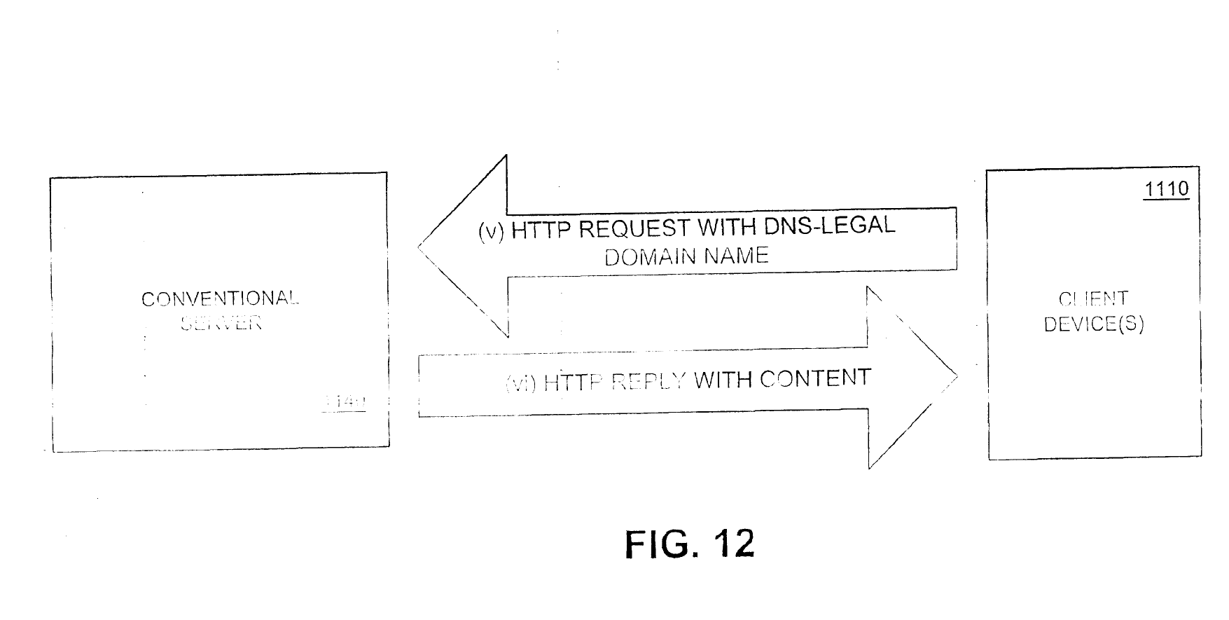

FIGS. 11 and 12 are schematic diagrams illustrating the interaction between the devices shown in the FIGs. In FIG. 11, a client device 1110 first sends and HTTP request to the participating name server 1120 that has been provide with the appropriate wildcard resource record shown in FIG. 10. The reply from name server 1120 includes a DNS response with the IP address of the URL forwarding agent 1130. The client device 1110 then sends another request to the URL forwarding agent 1130.

The URL forwarding agent 1130 illustrated in FIG. 11 is a server that accepts an HTTP request and, based upon the hostname component of the header in the request, replies with a redirect message identifying the location at the at which the desired content is available. The forwarding agent 1130 includes a data managing system 170 that is configured to operate according to the sequence shown in FIG. 9.

More specifically, the forwarding agent 1130 receives queries having a header with domain names that are encoded with a character map that is initially-unknown to the forwarding agent. This initially-undetermined character map may be a non-ASCII character map and/or include DNS-illegal characters. The forwarding agent 1130 responds with URLs that are encoded in the currently-preferred DNS-legal character map. However, as noted above, other character maps may also be used for the URL in the response depending upon the most current lingua franca of the Internet or the character map that is used in the query.

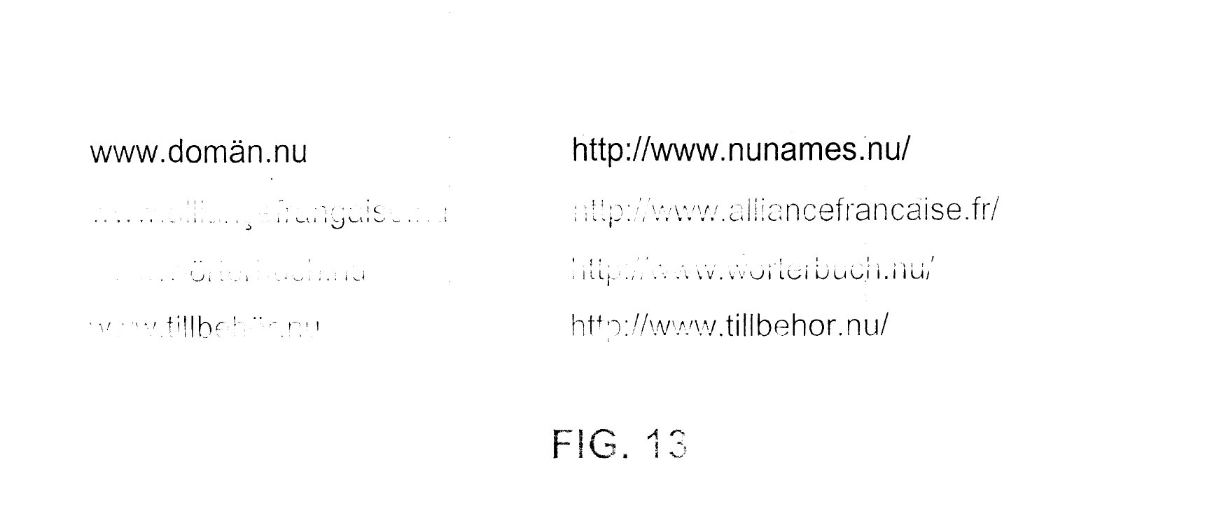

Several hypothetical records 1300 (FIG. 1300) from at least a portion of the data database 160 (FIG. 1) associated with the forwarding agent 1120 are shown in FIG. 13. The first column of each record contains a domain name that may include a non-ASCII character and/or DNS-illegal character. The domain names in the first column are preferably encoded in the same universal character map, such as the ISO-10646-1 or Unicode character map. Although each of the domain names illustrated in the first column of this example has been registered by the same ccTLD, registrations from other (current and future) top level domains may also be provided in the database. In fact, each top level domain on the Internet may operate its own URL forwarding agent or they may simply delegate the authority for one or more forwarding agents to service various subzones.

The second column of the records 1300 in FIG. 13 contains a corresponding DNS-legal domain name expression for each of the names in the first column. The names in the second column are preferably all encoded with a standard “preferred character map,” such as the seven-bit US-ASCII character map, or another character map that is supported by most hosts on the Internet. However, different character maps corresponding to a preferred character map for the top level domain of each name in the second column, or other groupings of domain names, may also be used.

Returning to FIG. 11, the forwarding agent 1130 first checks its database for a corresponding DNS-legal domain name and, if it finds one, returns a message containing information in the second column of FIG. 13. For the HTTP query shown in FIG. 11, the client device 1110 is redirected to the new URL by an HTTP full-response that includes a 302 status code in the status line, and the DNS-legal domain name of the redirected destination at which the information may be found. The mechanics of such HTTP requests and responses are generally set forth in RFCs 1945 and 2068. In simple terms, various HTTP responses allow client devices 1110 to be automatically redirected to a new location, or provided with a clickable link to the new address. Once the client device 1110 receives information concerning the new URL in the third step, it can retrieve the requested information from a conventional HTTP server 1140 as shown in the conventional fifth and sixth steps of FIG. 12.

If the forwarding agent 1130 does not find a corresponding DNS-legal domain name, it may return actual content such as a static web page. This web page could include information on how to register the name at issue. Although this example uses an HTTP service request, other types of services, such as mail services may be implemented in a similar fashion.

FIG. 9 illustrates one embodiment of a URL forwarding agent system 970 for use with the URL forwarding agent 1130 (FIG. 11) and generally corresponding to the system 370 in FIG. 3. Similar URL forwarding systems may be configured to correspond to system 470, 570, and 670 in FIGS. 4-6. At the top of FIG. 9, a conventional name server (not shown) with the appropriate wildcard resource record has directed the client 1100 to the URL forwarding agent 1130. Of course, the agent 1130 may also receive queries from other clients, including direct queries from those clients.

The query 902 is initially assumed to contain a DNS-legal domain name expression (that is optionally downcased) and sent for lookup at step 310 using conventional technology. However, the database for the forwarding agent system 970 includes records such as those shown in FIG. 13. If a match is found, then an HTTP redirect reply with a 302 status code is formulated and returned at step 916 to the client 1100 with the matching DNS-legal domain name from the database associated with the forwarding agent 1130. (DNS-illegal domain names may also be provided, and the process repeated.) If there is no match, then the query is next assumed to be encoded with a Unicode character map and sent to the UVCE module. If the unsuccessful lookup was attempted for a previously converted expression from LUTE at step 320, then the process returns to LUTE for another conversion and lookup until all conversions have been attempted or a match is found.

The validity of the assumed Unicode encoding is checked, and, if valid, the domain name portion of the queried expression is canonicalized at steps 322 and 324 and a second lookup is attempted. If a match is found in the database 12 on the second lookup attempt, then the client 1130 will receive an “HTTP redirect” reply message 916 that includes a “302” status code, and/or other appropriate codes, with the appropriate redirect message including a DNS-legal domain name expression for the conventional server 1140.

If there is no match on the second lookup attempt, then the domain name portion of the query is processed by the LUTE module as discussed in more detail above with regard to FIG. 3. LUTE performs a conversion from a third assumed character map to Unicode and either sends the conversion for a third attempted lookup (FIG. 3) or passes the result back to UVCE (FIG. 4) for validation and canonicalization before a third lookup is attempted. Alternatively, the validity of the third conversion may be checked without canonicalization (FIG. 5). Once all available conversions have been tried unsuccessfully (as may be explicitly or implicitly identified in the query), the forwarding agent 1130 (FIG. 11) then issues either an error message or a redirect reply message 930 to a predetermined location where, for example, information concerning how to register the domain name may be provided.

If both UVCE and LUTE are unable to produce a successful match in the forwarding agent database, then it is likely that the queried domain name expression has not been properly registered. In that case, as discussed above with regard to the WHOIS server, the forwarding agent 1130 may respond with a proposal for registering the name. Since the character map being used by the client is still unknown at this point, the registration proposal will ask the user to specify the character map with which for the requested domain name registration is encoded. Alternatively, or in addition to asking the user to specify a character map, the proposal may contain one or more encodings of the domain name and/or images of the domain name as it would appear using different character maps as discussed above. The user may then simply choose one of the displayed encodings and/or images for registration.

Alternatively, each character in the string to be registered may be presented as a separate image and/or with a corresponding name for the particular glyph represented by the image. The user may also be presented with options (such as a drop down box or link) for changing a particular character image to one that is phonetically, textually, contextually, positionally, or otherwise related to the first character shown in the registration proposal. Once the appropriate character string is identified by the user, additional registration instructions may be provided as an image and/or text which uses a language and/or character map corresponding to the character map encoding in the domain name being applied for.

If the image information for the domain name is presented as an image file (or link to an image file) in JPEG, PDF, and/or other image file formats, the registration proposal that is returned by the forwarding agent 1130 will be independent of the character map decoding being used by the client 1110 making the request. Alternatively, an image may be presented to the user instructing them how to change the settings on their web browser in order to view the registration proposal with the appropriate character map. The proposal may even use a particular character map (such as Japanese sift JIS) in its response and/or provide registration information and/or instructions for changing browser settings in a particular language (such as Japanese) depending on the location of the client making the request (such as a destination domain name including the “.jp” country code) or any tokens or other designations in the request. For example, the encoding may be obtained from a character set token or product token in the HTTP header in the original request by the client 1110.

The inventions described above are not limited to the mapping of host names to numeric IP addresses or other host names. They can also provide other information about internet resources that can be used with virtually all types of internetworking software including electronic mail (“e-mail”), remote terminal programs such as “Telnet,” file transfer programs such as “ftp,” and “web browsers” such as Netscape Navigator and Microsoft Internet Explorer. Consequently, the inventions described above may also be applied to WHOIS servers, mail hubs, web servers with virtual host features, WHOIS services, authentication and authorization systems, and other devices that work with host names within the bounds of the DNS, HTTP, and/or other protocols. For example, they may be used by domain registrars, corporate networks, certificate users, internet service providers, and network administrators.

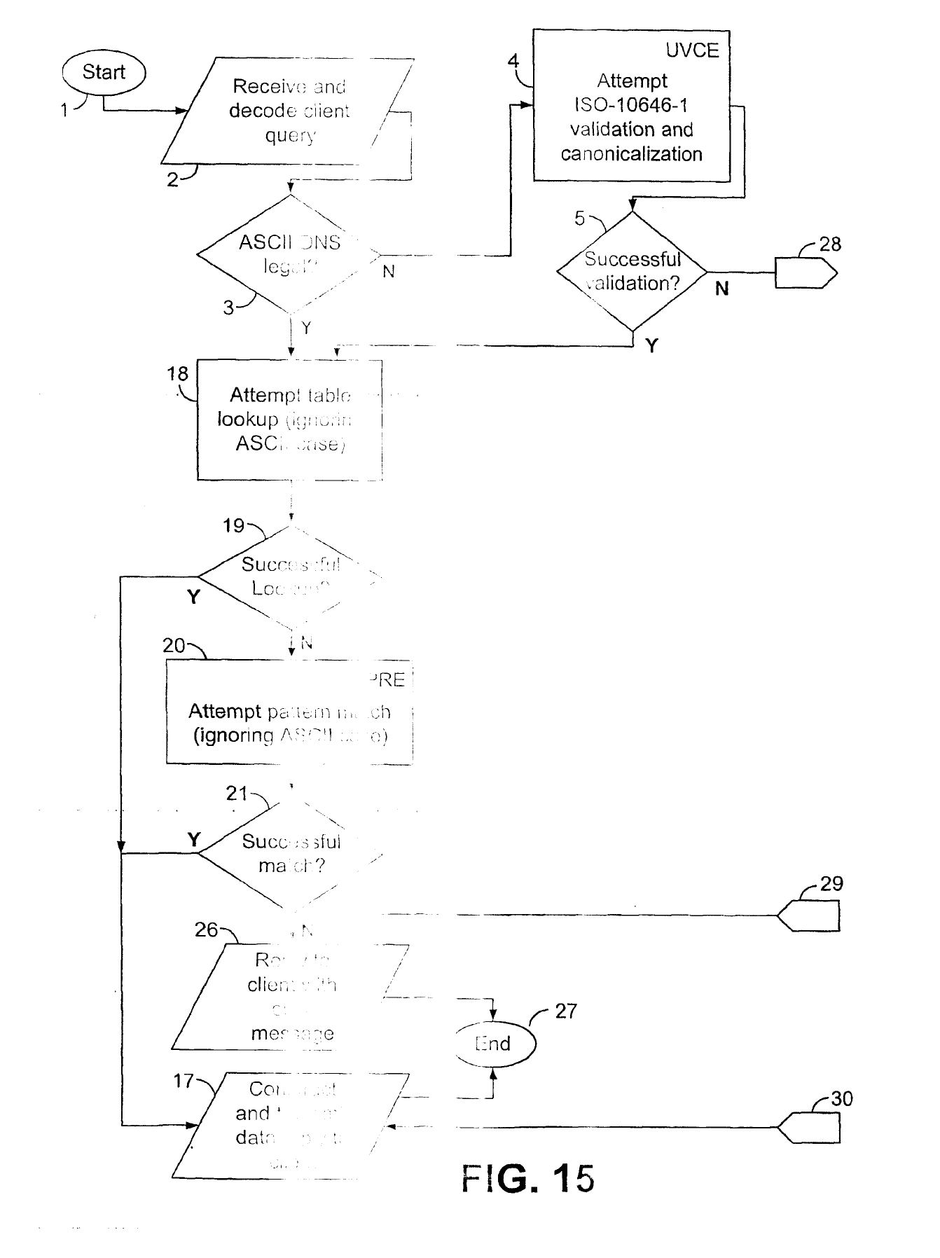

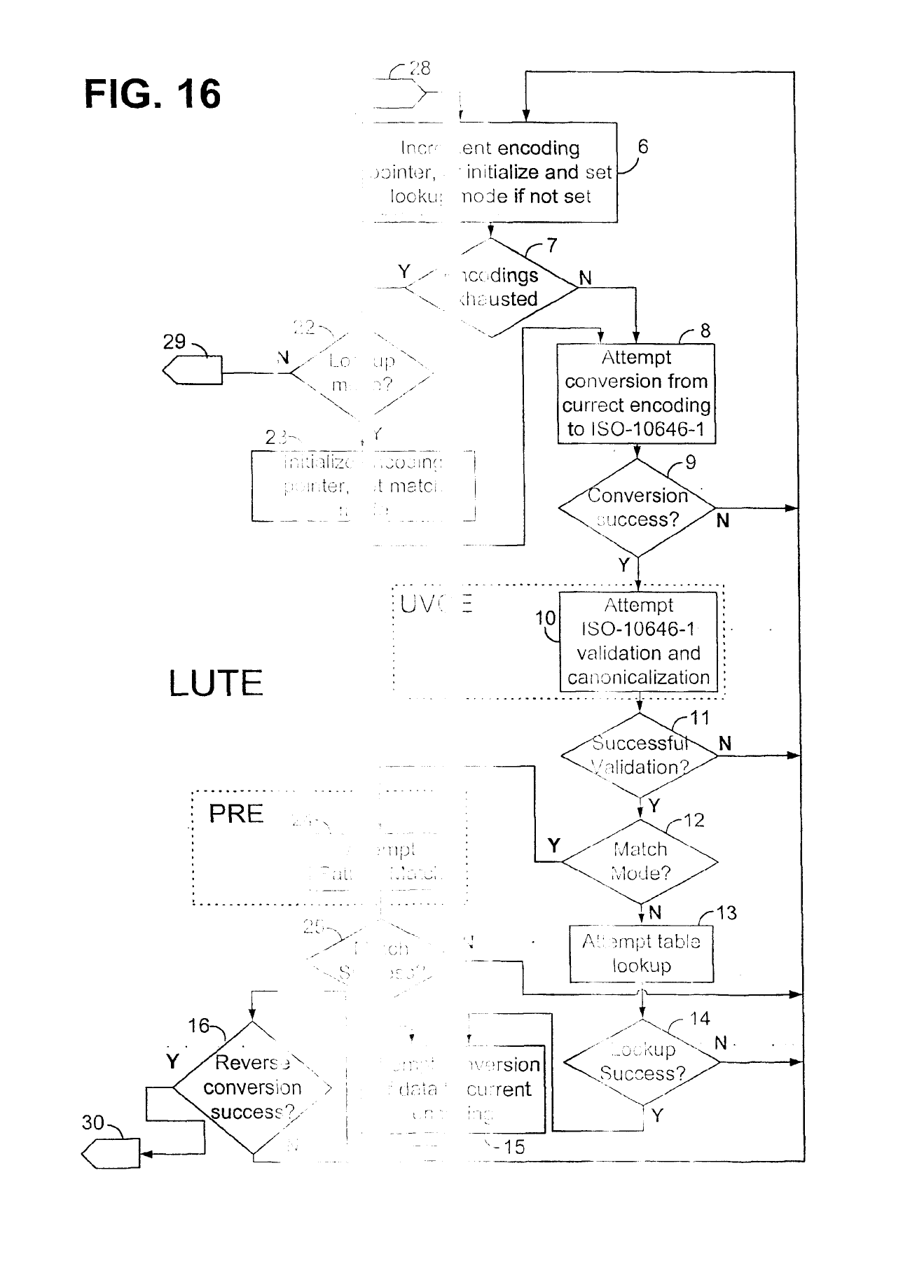

FIGS. 15 and 16 illustrate a schematic flowchart of other embodiments of the invention which includes pattern matching attempts by a pattern resolution engine (“PRE”) when the table lookups discussed above are unsuccessful. In this embodiment, the wildcard resource records discussed above may be are supplemented by pattern matching wildcard resource records such as:

[a-g].* IN A 1.2.3.4

[h-o].* IN A 1.2.3.5

[p-z].* IN A 1.2.3.6

The effect of these additional records is to identify domain names starting with different groups of letters of the alphabet and then to send those queries to other servers for mapping to the appropriate IP address and/or DNS-legal domain name. Although the patterns illustrated above pertain to Latin characters in the first portion of the domain name, other characters, character patterns, and/or positions within the domain name could also be used.

The technology shown in FIGS. 15 and 16 may be broadly described as a system for accommodating multiple character encodings in keyed database retrieval or insertion operations, without advance knowledge of the particular character encoding used in each key. This allows the system to interoperate with a wide variety of legacy systems that themselves use various mutually incompatible character encodings.

The invention is immediately applicable in all circumstances in which heuristic recognition of the character encodings of various text is useful. This is particularly relevant to software systems on the global Internet, but is not constrained thereto.

The basic system includes four components: a database proper implementing key-value retrievals in a single distinguished character encoding (usually a universal character encoding), a key validator that determines whether a key follows permitted patterns in the distinguished character encoding, an encoding converter that transforms text from and to the distinguished character encoding (with integral validation that the input text is actually a valid instantiation of the source character encoding), and an encoding iterator that applies the conversion, validation, and database components.

Optional components of the system are: a key normalization mechanism (which may be combined with the key validation component), a pattern matching mechanism by which multiple distinct keys are made to

correspond to the same value data (which is an extention to the database component), a mechanism that uses interactive dialogue to resolve ambiguous or failed identification of the character encoding of a key, a mechanism that converts text in some character encoding to an image in some graphical format, and a mechanism for constraining the set of character encodings to be considered by specifying the language of the text.

The basic system operates as follows where the numbers in parenthesis here correspond to the numerals shown in the “Intercoding Name Server Logical Flow Diagram” illustrated shown in FIGS. 15 and 16. A key is received (2) and passed to the key validator (4). If the key is determined to be valid (5), a database lookup (18) is attempted, and a reply is generated, either containing the found data (17), or containing a failure message if no data was found (26).

If the key is not valid (5), then control passes to the encoding iterator (6). The iterator's encoding pointer is initialized to the first character encoding in a prioritized list of encodings to be attempted. A conversion of the key is attempted (8) from the current encoding (the character encoding currently identified by the iterator's encoding pointer). If the conversion to the distinguished character encoding succeeds (9), the resulting converted key is validated (10).

If it validates (11), a database lookup is attempted (13). If data is found (14), a conversion of the data to the current encoding is attempted (15). If the conversion from the distinguished character encoding succeeds (16), a reply is generated (17), containing the conversion of the found data, and the process completes. If any of these steps fails, then the encoding pointer is incremented (6), and if the encoding list is exhausted (7), a reply containing a failure message is generated (26), and the process completes (27). Otherwise, the process repeats starting with the attempted conversion from the new current encoding (8).

In a first embodiment, the technology illustrated in FIGS. 15 and 16 is subsumed within a common, freely available server (e.g. Internet Software Consortium (ISC) “named”, a portion of ISC Berkeley Internet Name Domain (BIND)) for the Domain Name Service (DNS). In this embodiment, the server's key-value lookup table is used as the database proper. Before the query reaches the principal key validator, an additional simple test (3) is formed to determine if the query consists entirely of valid ASCII character patterns. If so, the query never reaches the principal validator (4), but instead is looked up directly (18, 19). This embodiment includes a key normalization system tightly integrated with the principal key validator (4 and 10), and normalization is necessary for all queries except those that never reach the principal validator. The case of characters is always ignored. The server's built in lookup table system (18) ignores ASCII case, and case is the only character attribute in ASCII affected by normalization, so key normalization is superfluous, and therefore not performed, for queries that consist entirely of valid ASCII character patterns. Additionally, a pattern matching mechanism (20, 21, 22, 23, 12, 24, 25) is tightly integrated with the server's built in table lookup system.

Note that functional units (4) and (10) are invocations of the same functional unit at different points in the procedural flow. The same holds for (13) and (18), and (20) and (24).

The first embodiment can be subsumed within any of a variety of directory servers, including other servers for DNS, and servers for Lightweight Directory Access Protocol (LDAP) and Network Information System (NIS). If an encoding that appears to be ordinary ASCII may in fact encode a non-ASCII key (for example, Row-based ASCII Compatible Encoding (RACE)), then the “N” path of (19) passes control to (6), and control never passes to (20).

In a second embodiment, the inventive technology operates to adapt the operation of a recursive directory server, such as a DNS server, to a multiple encoding environment. The query key sent by a client to the caching server can be in any of a variety of character encodings, but the recursive server converts the query key to a distinguished character encoding for retrieval of the requested information from elsewhere on the network (that is, for recursion). The character encoding of the recursive server's response matches the character encoding used by the client in the query key. The first embodiment normally, but not necessarily, accompanies the second embodiment.

The second embodiment operates specifically as follows. A query with a particular key is received from a client. The procedure from the first embodiment is optionally performed at this point, except that pattern matching (20, 21, 22, 23, 12, 24, 25) is not performed and error response (26) is deferred until the completion of the procedure of the second embodiment. Provided the first embodiment did not produce a successful reply and completion (17, 27), the second embodiment proceeds as in the basic system, with the following qualifications. If the first embodiment is not included, each database lookup is performed by querying a directory server on a remote host, as identified by delegation data known in some fashion by the second embodiment directory server. If the first embodiment is included, the local database in which the first embodiment lookups are performed is used by the second embodiment as follows: each query to a directory server on a remote directory server is prefaced by a lookup in the local database (which may obviate the remote query), delegation data is stored in and retrieved from the local database, and data contained in replies from remote hosts (including notification that a record does not exist) are entered into the local database. Thus, when first and second embodiments are combined, a data caching system results.

In a third embodiment, a name service client application, lightweight server, or client library (or a combination thereof) performs the operations of the basic system, qualified as follows. Submission to the system of the third embodiment is performed with a function call, and reply is by return of that function. The function may be a system call. Database lookup is performed by submitting a query to a directory server.

In a fourth embodiment, the inventive technology is subsumed within a virtual hosting web server. A web server's function is to honor requests in Hypertext Transfer Protocol (HTTP), supplying data as requested by clients and as determined by local lookups and retrievals. In a virtual hosting web server, the local lookup and retrieval operation is affected by the name by which the client addresses the server (this information is supplied by the client to the server in the request message header). This allows a single web server at a single numeric network address to take the place of many separate web servers. The virtual hosting web server can (and often does) act as a Uniform Resource Locator (URL) forwarding agent, efficiently and quickly redirecting clients to other web servers based on the name by which the client addressed the server. The operation of embodiment [D] is as in the basic system, with the addition of the key normalization mechanism and the pattern matching mechanism. A generic key-value database system is used as the database proper.

In a fifth embodiment, the inventive technology is subsumed within a WHOIS server, a server whose purpose is to provide technical and biographical information on Internet networks and domains and those responsible for them. This embodiment uses the same generic key-value database system used in the fourth embodiment. The fifth embodiment permits the client to explicitly specify the character encoding used in a query, and the character encoding that should be used in the reply, thereby overriding the algorithm of the basic system.

In a sixth embodiment, the inventive technology is subsumed within a conversion server—a server whose dedicated purpose is to perform character encoding validations, transformations, and categorizations. The operation is as in the basic system, with the addition of a normalization mechanism and facilities that permit the use of interactive dialogue to resolve ambiguous or failed character encoding identifications, that convert text to image formats, that permit constraints on the character encodings by specifying the language of the text at issue, and that allow various other adjustments and extensions of the basic system. The conversion server is itself subsumed by a complete registration system, which orchestrates the actual interactive dialogue by which ambiguous or failed character encoding identifications are positively resolved.

In a seventh embodiment, the inventive technology is subsumed within a mail server. A mail server honors Simple Mail Transfer Protocol (SMTP) requests, forwarding messages to other mail servers or passing them to local handlers as dictated by the active mailer configuration (including various databases). In this embodiment, the invention is used as in fourth embodiment. Email addresses are the keys, and database lookup is

resolution of the delivery address by the highly configurable address resolution subsystem.

In an eighth embodiment, the inventive technology is subsumed within the query interface of a database search facility such as a web search engine. The procedure is as in the basic system, with the search expression

submitted by the client acting as the key. In this embodiment, the client can explicitly specify the encoding used in the query, and the encoding desired in the reply.

All of the above embodiments described above with regard to FIGS. 15 and 16 use ISO-10646-1 encapsulated in Unicode Transformation Format 8 (UTF-8) as their internal character encoding. ISO-10646-1 is a universal character encoding, equivalent to Unicode 3.0. The embodiments can be readily adapted to use any other universal character encoding. In an alternate embodiment, the universal character encoding can be constructed by combining a set of distinct character encodings, and using a tagging scheme to identify the encoding in use in distinctly encoded segments of text.

Although the technology disclosed above has been described with regard to various preferred embodiments, it will be readily understood to one of ordinary skill in the art that various changes and/or modifications may be made without departing from the spirit of the invention. In general, the invention is only intended to be limited by the properly construed scope of the following claims.

1. A system for managing data, comprising:
a database for implementing a key value operation with a key having a predetermined encoding; and
means for iteratively converting the key from each of a plurality of encodings to the predetermined encoding before performing the key value operation with each converted key.

2. The system recited in claim 1, wherein the key value operation is selected from the group consisting of a key value insertion operation and a key value retrieval operation.

3. The system recited in claim 2, wherein the key value operation accommodates at least one wildcard.

4. The system recited in claim 1, further comprising means for verifying that a syntax of the converted key is valid.

5. The system recited in claim 1, further comprising means for normalizing the converted key.

6. The system recited in claim 1, wherein the encodings are character encodings.

7. The system recited in claim 6, wherein the character encodings are associated with the same language.

8. The system recited in claim 6, wherein the predetermined character encoding is Unicode.

9. The system recited in claim 6, further comprising means for providing image data corresponding to a result of the key value operations.

10. The system recited in claim 1, wherein the database includes name data.

11. The system recited in claim 1, wherein the database includes location data.

12. The system recited in claim 10, wherein the database includes location data.

13. The system recited in claim 10, wherein the name data includes domain name data.

14. The system recited in claim 11, wherein the location data includes IP address data.

15. The system recited in claim 12, wherein the name data includes domain name data and the address data includes IP address data.

16. A method for managing data, comprising the steps of:
implementing a key value operation in a database with a key having a predetermined encoding; and
iteratively converting the key from each of a plurality of encodings to the predetermined encoding before performing the key value operation with each converted key.

17. The method recited in claim 16, wherein the key value operation is selected from the group consisting of a key value insertion operation and a key value retrieval operation.

18. The method recited in claim 17, wherein the key value operation accommodates at least one wildcard.

19. The method recited in claim 16, further comprising the step of verifying that a syntax of the converted key is valid.

20. The method recited in claim 16, further comprising the step of normalizing the converted key.

21. The method recited in claim 16, wherein the encodings are character encodings.

22. The method recited in claim 21, wherein the character encodings are associated with the same language.

23. The method recited in claim 21, wherein the predetermined character encoding is Unicode.

24. The method recited in claim 21, further comprising the step of providing image data corresponding to a result of the key value operations.

25. The method recited in claim 16, wherein the database includes name data.

26. The method recited in claim 16, wherein the database includes location data.

27. The method recited in claim 10, wherein the database includes location data.

28. The method recited in claim 25, wherein the name data includes domain name data.

29. The method recited in claim 26, wherein the location data includes IP address data.

30. The method recited in claim 27, wherein the name data includes domain name data and the address data includes IP address data.

31. A computer readable medium for managing data, comprising:
logic for implementing a key value operation in a database with a key having. a predetermined encoding; and
logic for iteratively converting the key from each of a plurality of encodings to the predetermined encoding before performing the key value operation with each converted key.

32. The logic recited in claim 31, wherein the key value operation is selected from the group consisting of a key value insertion operation and a key value retrieval operation.

33. The logic recited in claim 32, wherein the key value operation accommodates at least one wildcard.

34. The logic recited in claim 31, further comprising logic for verifying that a syntax of the converted key is valid.

35. The system recited in claim 31, further comprising logic for normalizing the converted key.

36. The logic recited in claim 31, wherein the encodings are character encodings.

37. The logic recited in claim 36, wherein the character encodings are associated with the same language.

38. The logic recited in claim 36, wherein the predetermined character encoding is Unicode.

39. The logic recited in claim 36, further comprising logic for providing image data corresponding to a result of the key value operations.

40. The logic recited in claim 31, wherein the database includes name data.

41. The logic recited in claim 31, wherein the database includes location data.

42. The logic recited in claim 40, wherein the database includes location data.

43. The logic recited in claim 42, wherein the name data includes domain name data.

44. The logic recited in claim 42, wherein the location data includes IP address data.

45. The logic recited in claim 42, wherein the name data includes domain name data and the addresses data includes IP address data.

46. A system for managing data, comprising:
a database for implementing a key value operation with a key having a predetermined encoding; and
an iterative converter for converting the key from one of a plurality of encodings to the predetermined encoding before performing the key value operation with each converted key.

47. The system recited in claim 46, wherein the key value operation is selected from the group consisting of a key value insertion operation and a key value retrieval operation.

48. The system recited in claim 47, wherein the key value operation accommodates at least one wildcard.

49. The system recited in claim 46, further comprising a key validator for verifying that a syntax of the converted key is valid.

50. The system recited in claim 46, further comprising a key normalizer for normalizing the converted key.

51. The system recited in claim 46, wherein the encodings are character encodings.

52. The system recited in claim 51, wherein the character encodings are associated with the same language.

53. The system recited in claim 51, wherein the predetermined character encoding is Unicode.

54. The system recited in claim 46, further comprising an image generator for providing image data corresponding to a result of the key value operation.

55. The system recited in claim 46, wherein the database includes name data.

56. The system recited in claim 46, wherein the database includes location data.

57. The system recited in claim 55, wherein the database includes location data.

58. The system recited in claim 55, wherein the name data includes domain name data.

59. The system recited in claim 56, wherein the location data includes IP address data.

60. The system recited in claim 57, wherein the name data includes domain name data and the address data includes IP address data.

61. A data server, comprising:
means for receiving a request including an encoded portion;
means for iteratively converting the encoded portion of the request from each of a plurality of encodings to a predetermined encoding; and
means for responding to the request based upon at least one of the converted portions having the predetermined encoding.

62. The server recited in claim 61, further comprising means for verifying a syntax of each of the converted portions.

63. The server recited in claim 61, further comprising means for normalizing each of the converted portions.

64. The server recited in claim 61, wherein the encodings are character encodings.

65. The server recited in claim 64, wherein the character encodings are associated with the same language.

66. The server recited in claim 64, wherein the predetermined character encoding is Unicode.

67. The server recited in claim 61, wherein the response includes image data.

68. The server recited in claim 61, wherein the server is a daemon.

69. The server recited in claim 68, wherein the daemon is subsumed in a NAMED portion of the Berkeley Internet Name Domain software.

70. The server recited in claim 61, wherein the server is selected from the group consisting of a file server, a Network File System server, a Network Information Service server, a Domain Name System server, a WHOIS server, a File Transfer Protocol server, a Hyper Text Transfer Protocol server, a Simple Mail Transfer Protocol server, and a Lightweight Directory Access Protocol server.

71. A method of implementing a data service, comprising the steps of:
receiving a request including an encoded portion;
iteratively converting the encoded portion of the request from each of a plurality of encodings to a predetermined encoding; and
responding to the request based upon at least one of the converted portions having the predetermined encoding.

72. The method recited in claim 71, further comprising the step of verifying a syntax of each of the converted portions.

73. The method recited in claim 71, further comprising the step of normalizing each of the converted portions.

74. The method recited in claim 71, wherein the encodings are character encodings.

75. The method recited in claim 74, wherein the character encodings are associated with the same language.

76. The method recited in claim 74, wherein the predetermined character encoding is Unicode.

77. The method recited in claim 74, wherein the response includes image data.

78. The method recited in claim 71, wherein the service is a daemon.

79. The method recited in claim 78, wherein the daemon is subsumed in a NAMED portion of the Berkeley Internet Name Domain softaware.

80. The method recited in claim 71, wherein the data service follows a protocol selected from the group consisting of a Network File System protocol, a Network Information Service protocol, a Domain Name System protocol, WHOIS protocol, File Transfer Protocol, Hyper Text Transfer Protocol, a Simple Mail Transfer Protocol, and a Lightweight Directory Access Protocol.

81. A computer readable medium for implementing data service, comprising:
logic for receiving a request including an encoded portion;
logic for iteratively converting the encoded portion of the request from each of a plurality of encodings to a predetermined encoding; and
logic for responding to the request based upon at least one of the converted portions having the predetermined encoding.

82. The server recited in claim 81, further comprising logic for verifying a syntax of each of the converted portions.

83. The server recited in claim 81, further comprising logic for normalizing each of the converted portions.

84. The server recited in claim 81, wherein the encodings are character encodings.

85. The server recited in claim 84, wherein the character encodings are associated with the same language.

86. The server recited in claim 84, wherein the predetermined character encoding is Unicode.

87. The server recited in claim 84, wherein the response includes image data.

88. The server recited in claim 81, wherein the server is a daemon.

89. The server recited in claim 88, wherein the daemon is subsumed in a NAMED portion of the Berkeley Internet Name Domain software.

90. The server recited in claim 81, wherein the server is selected from the group consisting of a file server, a Network File System server, a Network Information Service server, a Domain Name System server, a WHOIS server, a File Transfer Protocol server, a Hyper Test Transfer Protocol server, a Simple Mail Transfer Protocol server, and a Lightweight Directory Access Protocol server.

91. A system for implementing the DNS protocol, comprising:
a name server for receiving a query including an encoded domain name expression;
means for iteratively converting the encoded domain name expression from each of a plurality of character encodings to a predetermined character encoding; and
means for providing a response to the query based upon at least one of the converted domain name expressions having the predetermined character encoding.

92. The system recited in claim 91, wherein the response includes data representing a second domain name expression.

93. The system recited in claim 92, wherein the second domain name expression is a fully-qualified domain name expression.

94. The system recited in claim 92, wherein the data includes image data.

95. The system recited in claim 91, wherein the response includes an HTTP response.

96. The system recited in claim 91, wherein the HTTP response includes a redirection status code.

97. The system recited in claim 91, further comprising means for providing the query to the name server.

98. The system recited in claim 97, wherein the providing means includes a second name server having a wildcard resource record for directing the query to the first name server.

99. The system recited in claim 91, further comprising means for verifying a syntax of each converted domain name expression.

100. The system recited in claim 91 wherein the each of the plurality of character encodings are associated with the same language.

101. A system for implementing the Domain Name System (DNS) protocol in distributed name space, comprising a name server for mapping a queried domain name expression encoded with an initially-undetermined character map to a resource record.

102. The system recited in claim 101 wherein said initially-undetermined character map includes characters which are not DNS-legal.

103. The system recited in claim 101 wherein said initially-undetermined character map includes non-ASCII characters.

104. The system recited in claim 101 including modified code operating in conjunction with the Berkeley Internet Name Domain (“BIND”) implementation of the DNS protocol.

105. The system recited in claim 101 further comprising a Referral Domain Name Service for determining whether the queried domain name expression contains a 7-bit DNS-legal character string, 8-bit DNS-legal character string, or another type of character string.

106. The system recited in claim 101 wherein the Referral Domain Name Service also determines whether said queried domain name expression contains a special character string.

107. The system recited in claim 101, further comprising a Referral Domain Name Service for determining whether the queried domain name expression contains an 8-bit DNS-legal character strings and for referring said 8-bit DNS-legal expression to a Unicode Validation and Canonicalization Engine for determining whether the referred 8-bit DNS-legal expression has been encoded with a universal character map.

108. The system recited in claim 107, wherein, prior to mapping, said Unicode Validation and Canonicalization Engine also validates, downcases, and decomposes said 8-bit DNS-legal expression which has been determined to be encoded with the Unicode universal character map.

109. The system recited in claim 101, further comprising a Legacy Unicodification Trial Engine for converting said queried domain name expression to a universal character map from another character map prior to attempting a look-up of the converted expression.

110. The system recited in claim 109, wherein, after an unsuccessful mapping attempt, the Legacy Unicodification Trial Engine converts the queried domain name expression to a universal character map from another different character map prior to attempting another look-up of the converted expression.

111. The system recited in claim 105, further comprising a Legacy Unicodification Trial Engine for converting said queried domain name expression containing said other type of string to a universal character map prior to attempting a look-up of the converted expression.

112. The system recited in claim 109, wherein, after an unsuccessful look-up, the Legacy Unicodification Trial Engine converts the queried domain name expression to Unicode from another different character map prior to attempting another look-up of the converted expression.

113. A virtual internationalized domain name system, comprising a URI forwarding agent for attempting a mapping of a queried domain name expression that is encoded with an initially-undetermined character map to a corresponding DNS-legal domain name expression.

114. The virtual internationalized domain name system recited in claim 113 wherein said queried domain name expression includes at least one DNS-illegal character.

115. The virtual internationalized domain name system recited in claim 113 wherein said initially-undetermined character map is a non-ASCII character map.

116. The virtual internationalized domain name system recited in claim 115 wherein said initially-undetermined character map includes a binary code unit that is longer than seven bits.

117. The virtual internationalized domain name system recited in claim 116 wherein said queried domain name expression includes at least one DNS-illegal character.

118. The virtual internationalized domain name system recited in claim 113 further comprising a name server with a wildcard resource record for referring the queried domain name expression to the URI forwarding agent.

119. The virtual internationalized domain name system as recited in claim 113 wherein said URI forwarding agent includes a first module for verifying that the queried domain expression is encoded with a Unicode/UTF-8 character map and canonicalizing the verified expression prior to said attempted mapping.

120. The virtual internationalized domain system as recited in claim 119 wherein said canonicalizing uses Normalization Form KD.

121. The virtual internationalized domain name system as recited in claim 113 wherein said URL forwarding agent includes a module for converting the queried domain name expression to a preferred character map prior to said attempted mapping.

122. The virtual internationalized domain name system as recited in claim 121 wherein said preferred character map is a universal character map.

123. The virtual internationalized domain name system as recited in claim 122 wherein the universal character map is Unicode with transformation format UTF-8.

124. The virtual internationalized domain name system as recited in claim 119 wherein said URL forwarding agent includes a second module for converting the queried domain name expression to a preferred character map prior to a second attempted mapping.

125. The virtual internationalized domain name system as recited in claim 124 wherein the preferred character map is Unicode with transformation format UTF-8.

126. The virtual internationalized domain name system as recited in claim 125 wherein the first module also verifies and canonicalizes the encoding of the converted expression prior said second attempted mapping.

127. The virtual internationalized domain name system recited in claim 126 further comprising a name server with a wildcard resource record for referring the queried domain name expression to the URI forwarding agent.

128. The virtual internationalized domain name system as recited in claim 127 wherein, when said second attempted mapping is unsuccessful, the URI forwarding agent maps the queried domain name expression to a predetermined domain name expression.

129. A method of implementing a virtual internationalized domain name system comprising the steps of:
receiving a query with a domain name expression that is encoded with an initially-undetermined character map; and
attempting a mapping of the queried domain name expression to a DNS-legal domain name expression.

130. The method of implementing a virtual internationalized domain name system recited in claim 129 wherein said queried domain name expression includes at least one DNS-illegal character.

131. The method of implementing. a virtual internationalized domain name system recited in claim 129 wherein said initially-undetermined character map is a non-ASCII character map.

132. The method of implementing a virtual internationalized domain name system recited in claim 129 wherein said initially-undetermined character map includes a binary code unit that is longer than seven bits.

133. The virtual internationalized domain name system recited in claim 132 wherein said queried domain name expression includes at least one DNS-illegal character.

134. The method of implementing a virtual internationalized domain name system as recited in claim 129 wherein during said receiving step, the queried domain name expression is received from a name server in response to finding a wildcard resource record in a zone file of the name server.

135. The method of implementing a virtual internationalized domain name system as recited in claim 129 further comprising the step of verifying whether the queried domain expression is encoded with a Unicode/UTF-8 character map and canonicalizing the verified expression prior to said attempted mapping.

136. The method of implementing a virtual internationalized domain name system as recited in claim 129 further comprising the step of converting the queried domain name expression to a universal character map before said attempted mapping step.

137. The method of implementing a virtual internationalized domain name system as recited in claim 136 wherein said universal character map is Unicode/UTF-8.

138. The method of implementing a virtual internationalized domain name system as recited in claim 137 further comprising the step of verifying whether the converted domain name expression is encoded with a Unicode/UTF-8 character map and canonicalizing the verified expression prior to said attempted mapping.

139. The method of implementing a virtual internationalized domain name system as recited in claim 135 further comprising the step of, after an unsuccessful verification, converting the queried domain name expression to a universal character map before said attempted a second mapping of the queried domain name expression to a DNS-legal domain name expression.

140. The method of implementing a virtual internationalized domain name system as recited in claim 139 wherein said universal character map is Unicode/UTF-8 and said canonicalization uses Normalization Form KD.

141. The method of implementing a virtual internationalized domain name system as recited in claim 140 further comprising the step of verifying whether the converted domain name expression is encoded with a Unicode/UTF-8 character map and canonicalizing the verified expression prior to said second attempted mapping of the converted domain name expression.

142. The method of implementing a virtual internationalized domain name system as recited in claim 141 wherein during said receiving step, the queried domain name expression is received from a name server in response to finding a wildcard resource record in a zone file of the name server.

143. The method of implementing a virtual internationalized domain name system as recited in claim 142 further comprising the step of, when all attempted mappings are unsuccessful, mapping the queried domain name expression to a predetermined domain name expression.

144. A virtual internationalized domain name system, comprising a name server with a wildcard resource record for referring a queried domain name expression that is encoded with an initially-undetermined character map expression to a URI forwarding agent.

145. The virtual internationalized domain name system recited in claim 144 wherein said queried domain name expression includes at least one DNS-illegal character.

146. The virtual internationalized domain name system recited in claim 144 wherein said initially-undetermined character map is a non-ASCII character map.

147. The virtual internationalized domain name system recited in claim 146 wherein said initially-undetermined character map includes a binary code unit that is longer than seven bits.

148. The virtual internationalized domain name system recited in claim 147 wherein said queried domain name expression includes at least one DNS-illegal character.

149. A method of implementing a virtual internationalized domain name system, comprising the steps of:
receiving a query with a domain name expression that is encoded with an initially-undetermined character map; and
referring the query to a URI forwarding agent for mapping the queried domain name expression to another domain name expression.

150. The method of implementing a internationalized domain name system recited in claim 149 wherein said queried domain name expression includes at least one DNS-illegal character.

151. The method of implementing a virtual internationalized domain name system recited in claim 149 wherein said initially-undetermined character map is a non-ASCII character map.

152. The method of implementing a virtual internationalized domain name system recited in claim 151 wherein said initially-undetermined character map includes a binary code unit that is longer than seven bits.

153. The method of implementing a virtual internationalized domain name system recited in claim 152 wherein said queried domain name expression includes at least one DNS-illegal character.

154. The method of implementing a virtual internationalized domain name system recited in claim 153 wherein said other domain name expression is DNS-legal.

155. A URI forwarding agent arranged to map a queried domain name expression that is encoded with an initially-undetermined character map to a corresponding DNS-legal domain name expression.

156. The URI forwarding agent recited in claim 155 wherein said queried domain name expression includes at least one DNS-illegal character.

157. The URI forwarding agent recited in claim 155 wherein said initially-undetermined character map is a non-ASCII character map.

158. The URI forwarding agent recited in claim 157 wherein said initially-undetermined character map includes a binary code unit that is longer than seven bits.

159. The URI forwarding agent recited in claim 158 wherein said queried domain name expression includes at least one DNS-illegal character.

160. The URI forwarding agent recited in claim 155, further comprising a first module for verifying that the queried domain expression is encoded with a Unicode/UTF-8 character map and for canonicalizing the verified expression prior to a first attempt at said mapping.

161. The URI forwarding agent recited in claim 155 further comprising a module for converting the queried domain name expression to a preferred character map prior to said. mapping.

162. The URI forwarding agent recited in claim 161 wherein said preferred character map is a universal character map.

163. The URI forwarding agent recited in claim 162 wherein the universal character map is Unicode.

164. The URI forwarding agent recited in claim 163 wherein the universal character map is Unicode/UTF-8.

165. The URI forwarding agent recited in claim 160 wherein said URL forwarding agent includes a second module for converting the queried domain name expression to a preferred character map prior to a second attempt at said mapping.

166. The URI forwarding agent recited in claim 165 wherein the preferred character map is Unicode/UTF-8.

167. The URI forwarding agent recited in claim 166 wherein the first module also verifies and canonicalizes the encoding of the converted expression using Normalization Form KD prior said second attempted mapping.

168. The URI forwarding agent recited in claim 167 wherein, when said second attempted mapping is unsuccessful, the URI forwarding agent maps the queried domain name expression to a predetermined domain name expression.

169. A system for accommodating multiple character encodings in a keyed database retrieval and insertion operation without having prior knowledge of the particular character encoding that is used for each key, the system comprising:
a database for implementing a key value retrieval using a universal character encoding;
a key validator for determining whether the key follows an acceptable pattern for the universal character encoding;
an encoding converter for transforming the key to the universal character encoding from a different character encoding when the key does not follow an acceptable pattern in the universal character encoding; and
an iterator for controlling the database, key validator, and encoding converter to perform in an iterative fashion using a plurality of said different character encodings.

170. The system recited in claims 169, further comprising a transformed key validator for determining whether the transformed key follows an acceptable pattern for the universal character encoding.

171. The system recited in claim 169 wherein said key validator also normalizes the key.

172. The system recited in claim 171, wherein said normalization includes downcasing and decomposition.

173. The system recited in claim 172, wherein said universal character code is Unicode and said normalization is Normalization Form KC.

174. The system recited in claim 172, wherein said universal character code is Unicode and said normalization is Normalization Form KD.

175. The system recited in claim 169 wherein said database includes DNS resource records.

176. The system recited in claim 171 wherein said database includes DNS resource records.

177. The system recited in claim 174 wherein said database includes DNS resource records.

178. The system recited in claim 175 subsumed into one of the group consisting of a DNS service, a virtual hosting web service, a WHOIS service, a conversion service, a registration service, and a URL forwarding agent.

179. A system for implementing the Domain Name System (DNS) protocol in distributed name space, comprising a name server for mapping a queried domain name expression encoded with an initially-undetermined character map to a resource record.

180. The system recited in claim 179 wherein said initially-undetermined character map includes characters which are not DNS-legal.

181. The system recited in claim 179 wherein said initially-undetermined character map includes non-ASCII characters.

182. The system recited in claim 179 including modified code operating in conjunction with the Berkeley Internet Name Domain (“BIND”) implementation of the DNS protocol.

183. The system recited in claim 179 further comprising a Referral Domain Name Service for determining whether the queried domain name expression contains a 7-bit DNS-legal character string, 8-bit DNS-legal character string, or another type of character string.

184. The system recited in claim 179 wherein the Referral Domain Name Service also determines whether said queried domain name expression contains a special character string.

185. The system recited in claim 179, further comprising a Referral Domain Name Service for determining whether the queried domain name expression contains an 8-bit DNS-legal character strings and for referring said 8 bit DNS-legal expression to a Unicode Validation and Canonicalization Engine for determining whether the referred 8-bit DNS-legal expression has been encoded with a universal character map.

186. The system recited in claim 185, wherein, prior to mapping, said Unicode Validation and Canonicalization Engine also validates, downcases, and decomposes said 8-bit DNS-legal expression which has been determined to be encoded with the Unicode universal character map.

187. The system recited in claim 179, further comprising a Legacy Unicodification Trial Engine for converting said queried domain name expression to a universal character map from another character map prior to attempting a look-up of the converted expression.

188. The system recited in claim 187, wherein, after an unsuccessful mapping attempt, the Legacy Unicodification Trial Engine converts the queried domain name expression to a universal character map from another different character map prior to attempting another look-up of the converted expression.

189. The system recited in claim 183, further comprising a Legacy Unicodification Trial Engine for converting said queried domain name expression containing said other type of string to a universal character map prior to attempting a look-up of the converted expression.

190. The system recited in claim 187, wherein, after an unsuccessful look-up, the Legacy Unicodification Trial Engine converts the queried domain name expression to Unicode from another different character map prior to attempting another look-up of the converted expression.

191. A Network Information Center, comprising:
a registration web server;
a relational database management system; and
a system for implementing the Domain Name System (DNS) protocol in distributed name space with a name server for mapping resource records to queried domain name expressions that are encoded with any initially-undetermined character map.

192. The server recited in claim 61, wherein the response includes multiple conversions of the encoded portion.

193. The method of implementing a data service recited in claim 71, wherein the response includes multiple conversions of the encoded portion.

194. The computer readable medium recited in claim 81, wherein the response includes multiple conversions of the encoded portion.

195. A conversion server, comprising:
means for receiving a string of characters from a client;
means for converting the string of characters from each of a plurality of encodings to a predetermined encoding; and
means for providing each of the converted strings to the client.

196. The conversion server recited in claim 195, wherein the encodings are character encodings.

197. The conversion server recited in claim 196, wherein the string of characters is a domain name expression in an initially-undetermined character encoding.

198. The conversion server recited in claim 197, wherein the predetermined character encoding is Unicode.

199. A method of implementing a conversion service, comprising the steps of:
receiving a string of characters from a client;
converting the string of characters from each of a plurality of encodings to a predetermined encoding; and
providing each of the converted strings to the client.

200. The method recited in claim 199, wherein the encodings are character encodings.

201. The method recited in claim 200, wherein the string of characters is a domain name expression in an initially-undetermined character encoding.

202. The method recited in claim 201, wherein the predetermined character encoding is Unicode.

203. A computer readable medium for implementing a conversion service, comprising:
logic for receiving a string of characters from a client;
logic for converting the string of characters from each of a plurality of encodings to a predetermined encoding; and
logic for providing each of the converted strings to the client.

204. The computer readable medium recited in claim 203, wherein the encodings are character encodings.

205. The computer readable medium recited in claim 204, wherein the string of characters is a domain name expression in an initially-undetermined character encoding.

206. The computer readable medium recited in claim 205, wherein the predetermined character encoding is Unicode.

207. A conversion server, comprising:
an input device for receiving a string of characters;
a converter for converting the string of characters from each of a plurality of encodings to a predetermined encoding; and
an output device for providing each of the converted strings to a client.

208. The conversion server recited in claim 207, wherein the encodings are character encodings.

209. The conversion server recited in claim 208, wherein the string of characters is a domain name expression in an initially-undetermined character encoding.

210. The conversion server recited in claim 209, wherein the predetermined character encoding is Unicode.

211. The conversion server recited in claim 210, further comprising a validator for verifying that a syntax of each converted domain name is valid.

212. The conversion server recited in claim 210, further comprising a normalizer for normalizing each converted domain name.

213. The conversion server recited in claim 210, wherein the plurality of encodings is identified in the request.
